(19) United States
(12) Patent Application Publication
(10) Pub. No.: US 2020/0126109 A1
(43) Pub. Date: Apr. 23, 2020

(54) METHOD, APPARATUS, AND SYSTEM FOR DISPLAYING AN INTERACTIVE DYNAMIC PRODUCT DISPLAY INTERFACE ON AN ELECTRONIC DEVICE

(71) Applicant: Haley Frame, Losantville, IN (US)

(72) Inventor: Haley Frame, Losantville, IN (US)

(21) Appl. No.: 16/655,040

(22) Filed: Oct. 16, 2019

Related U.S. Application Data
(60) Provisional application No. 62/749,504, filed on Oct. 23, 2018.

(51) Int. Cl. G06Q 30/02; G06F 3/0482; G06F 3/0484

(52) U.S. Cl. CPC G06Q 30/0239; G06F 3/0484; G06F 3/0482

(57) ABSTRACT

A computing system of an electronic device is configured to receive a selection of an image of one or more objects, transmit the image to one or more other electronic devices for display in response to receiving the selection of the image. The image includes an indication that the computing system has received the selection of the image. The computing system is configured to identify a quantity of at least one other electronic device of the one or more other electronic devices that receives a selection of the image after the image is transmitted to the one or more other electronic devices for display, determine a location of the electronic device, and display one or more commercial rewards based on the quantity of the at least one other electronic device that receives the selection of the image, and the location of the electronic device.

### CROSS-REFERENCE TO RELATED APPLICATIONS

This application claims the benefit of Provisional Application No. 62/749,504, entitled “METHOD, APPARATUS, AND SYSTEM FOR DISPLAYING AN INTERACTIVE DYNAMIC PRODUCT DISPLAY INTERFACE ON AN ELECTRONIC DEVICE”, and filed on Oct. 23, 2018, the disclosure of which is hereby incorporated by reference in its entirety.

### TECHNICAL FIELD

The present disclosure relates to displaying an interactive dynamic product display interface to promote product interest and encourage consumers to patronize brick and mortar retail stores.

### BACKGROUND

Product manufacturers, retail stores, and other private enterprises (hereinafter “producers”) utilize web-based product displays to promote sales of products. Product displays through social networks allow the producers to reach out to consumers directly and through social network sharing. Currently, the producers fail to provide an incentive for the majority of consumers to share product displays with other consumers in their social networks.

### SUMMARY

This disclosure provides systems and methods for displaying an interactive gaming interface on an electronic device.

In a first embodiment, the disclosure provides an electronic device including a computing system. The computing system includes a memory and at least one processor. The computing system is configured to receive a selection of an image of one or more objects. The computing system is also configured to transmit the image to one or more other electronic devices for display in response to receiving the selection of the image. When the image is transmitted to the one or more other electronic devices for display, the image includes an indication that the computing system has received the selection of the image. The computing system is further configured to identify a quantity of at least one other electronic device of the one or more other electronic devices that receives a selection of the image after the image is transmitted to the one or more other electronic devices for display. In addition, the computing system is configured to determine a location of the electronic device. The computing system is configured to display one or more commercial rewards based on the quantity of the at least one other electronic device of the one or more other electronic devices that receives the selection of the image, and the location of the electronic device.

In a second embodiment, the disclosure provides a method implemented by a computing system of an electronic device. The method includes receiving, by the computing system, a selection of an image of one or more objects. The method also includes transmitting, by the computing system, the image to one or more other electronic devices for display in response to receiving the selection of the image. When the image is transmitted to the one or more other electronic devices for display, the image includes an indication that the computing system has received the selection of the image. The method further includes identifying, by the computing system, a quantity of at least one other electronic device of the one or more other electronic devices that receives a selection of the image after the image is transmitted to the one or more other electronic devices for display. In addition, the method includes determining, by the computing system, a location of the electronic device. The method includes displaying, by the computing system, one or more commercial rewards based on the quantity of the at least one other electronic device of the one or more other electronic devices that receives the selection of the image, and the location of the electronic device.

In a third embodiment, the disclosure provides a non-transitory, computer-readable storage medium. The non-transitory, computer-readable storage medium stores one or more executable instructions that, when executed by at least one processor, causes the at least one processor to receive a selection of an image of one or more objects. The one or more executable instructions that, when executed by at least one processor, also cause the at least one processor to transmit the image to one or more other electronic devices for display in response to receiving the selection of the image. When the image is transmitted to the one or more other electronic devices for display, the image includes an indication that the at least one processor has received the selection of the image. The one or more executable instructions that, when executed by at least one processor, further cause the at least one processor to identify a quantity of at least one other electronic device of the one or more other electronic devices that receives a selection of the image after the image is transmitted to the one or more other electronic devices for display. In addition, the one or more executable instructions that, when executed by at least one processor, cause the at least one processor to determine a location of the at least one processor. The one or more executable instructions that, when executed by at least one processor, cause the at least one processor to display one or more commercial rewards based on the quantity of the at least one other electronic device of the one or more other electronic devices that receives the selection of the image, and the location of the at least one processor.

In a fourth embodiment, the disclosure provides an electronic device including a computing system. The computing system includes a memory and at least one processor. The computing system is configured to receive a selection of at least a first object of one or more objects within an image. The computing system is also configured to transmit the image to one or more other electronic devices for display in response to receiving the selection of at least the first object. When the image is transmitted to the one or more other electronic devices for display, the image includes an indication that the computing system has received the selection of at least the first object. The computing system is further configured to identify a quantity of at least one other electronic device of the one or more other electronic devices that receives a selection of at least one object of the one or more objects within the image after the image is transmitted to the one or more other electronic devices for display. In addition, the computing system is configured to determine a location of the electronic device. The computing system is configured to display one or more commercial rewards based on the quantity of the at least one other electronic device of the one or more other electronic devices that receives the selection of at least one object of the one or more objects within the image, and the location of the electronic device.

In a fifth embodiment, the disclosure provides a method implemented by a computing system of an electronic device. The method includes receiving, by the computing system, a selection of at least a first object of one or more objects within an image. The method also includes transmitting, by the computing system, the image to one or more other electronic devices for display after receiving the selection of at least the first object. When the image is transmitted to the one or more other electronic devices for display, the image includes an indication that the computing system has received the selection of at least the first object. The method further includes identifying, by the computing system, a quantity of at least one other electronic device of the one or more other electronic devices that receives a selection of at least one object of the one or more objects within the image after the image is transmitted to the one or more other electronic devices for display. In addition, the method includes determining, by the computing system, a location of the electronic device. The method includes displaying, by the computing system, one or more commercial rewards based on the quantity of the at least one electronic device of the one or more other electronic devices that receives the selection of at least one object of the one or more objects within the image, and the location of the electronic device.

In a sixth embodiment, the disclosure provides a non-transitory, computer-readable storage medium. The non-transitory, computer-readable storage medium stores one or more executable instructions that, when executed by at least one processor, causes the at least one processor to receive a selection of at least a first object of one or more objects within an image. The one or more executable instructions that, when executed by at least one processor, also cause the at least one processor to transmit the image to one or more other electronic devices for display after receiving the selection of at least the first object. When the image is transmitted to the one or more other electronic devices for display, the image includes an indication that the at least one processor has received the selection of at least the first object. The one or more executable instructions that, when executed by at least one processor, further cause the at least one processor to identify a quantity of at least one other electronic device of the one or more other electronic devices that receives a selection of at least one object of the one or more objects within the image after the image is transmitted to the one or more other electronic devices for display. In addition, the one or more executable instructions that, when executed by at least one processor, cause the at least one processor to determine a location of the at least one processor. The one or more executable instructions that, when executed by at least one processor, cause the at least one processor to display one or more commercial rewards based on the quantity of the at least one other electronic device of the one or more other electronic devices that receives the selection of the at least one object of the one or more objects within the image, and the location of the at least one processor.

In a seventh embodiment, the disclosure provides an electronic device including a computing system. The computing system includes a memory and at least one processor. The computing system is configured to receive a selection of at least one object of one or more objects within an image when the electronic device is located a first location. The computing system is also configured to transmit the image to one or more other electronic devices for display after receiving the selection of the at least one object of the one or more objects within the image. When the image is transmitted to the one or more other electronic devices for display, the image includes an indication that the computing system has received the selection of the at least one object. The computing system is further configured to identify a quantity of at least one other electronic device of the one or more other electronic devices that receives a selection of at least one object of the one or more objects within the image after the image is transmitted to the one or more other electronic devices for display. In addition, the computing system is configured to determine when the electronic device moves a distance towards a second location that is different from the first location. The computing system is configured to display one or more commercial rewards based on the quantity of the at least one other electronic device of the one or more other electronic devices that receives a selection of at least one object of the one or more objects within the image in response to determining when the electronic device moves the distance towards the second location.

In an eighth embodiment, the disclosure provides a method implemented by a computing system of an electronic device. The method includes receiving, by the computing system, a selection of at least one object of one or more objects within an image when the electronic device is located a first location. The method also includes transmitting, by the computing system, the image to one or more other electronic devices for display after receiving the selection of the at least one object of the one or more objects within the image. When the image is transmitted to the one or more other electronic devices for display, the image includes an indication that the computing system has received the selection of the at least one object. The method further includes identifying, by the computing system, a quantity of at least one other electronic device of the one or more other electronic devices that receives a selection of at least one object of the one or more objects within the image after the image is transmitted to the one or more other electronic devices for display. In addition, the method includes determining, by the computing system, when the electronic device moves a distance towards a second location that is different from the first location. The method includes displaying, by the computing system, one or more commercial rewards based on the quantity of the at least one other electronic device of the one or more other electronic devices that receives a selection of at least one object of the one or more objects within the image in response to determining when the electronic device moves the distance towards the second location.

In a ninth embodiment, the disclosure provides a non-transitory, computer-readable storage medium. The non-transitory, computer-readable storage medium stores one or more executable instructions that, when executed by at least one processor, causes the at least one processor to receive a selection of at least one object of one or more objects within an image when the electronic device is located a first location. The one or more executable instructions that, when executed by at least one processor, also cause the at least one processor to transmit the image to one or more other electronic devices for display after receiving the selection of the at least one object of the one or more objects within the image. When the image is transmitted to the one or more other electronic devices for display, the image includes an indication that the at least one processor has received the selection of the at least one object. The one or more executable instructions that, when executed by at least one processor, further cause the at least one processor to identify a quantity of at least one other electronic device of the one or more other electronic devices that receives a selection of at least one object of the one or more objects within the image after the image is transmitted to the one or more other electronic devices for display. In addition, the one or more executable instructions that, when executed by at least one processor, cause the at least one processor to determine when the electronic device moves a distance towards a second location that is different from the first location. The one or more executable instructions that, when executed by at least one processor, cause the at least one processor to display one or more commercial rewards based on the quantity of the at least one other electronic device of the one or more other electronic devices that receives a selection of at least one object of the one or more objects within the image in response to determining when the electronic device moves the distance towards the second location.

In a tenth embodiment, the disclosure provides an electronic device including a computing system. The computing system includes a memory and at least one processor. The computing system is configured to receive a selection of at least a first object of one or more objects within an image. The computing system is also configured to transmit the image to one or more other electronic devices for display in response to receiving the selection of at least the first object. When the image is transmitted to the one or more other electronic devices for display, the image includes an indication that the computing system has received the selection of at least the first object. The computing system is further configured to identify a quantity of at least one selection of at least one object of the one or more objects within the image from at least one other electronic device of the one or more other electronic devices after the image is transmitted to the one or more other electronic devices for display. In addition, the computing system is configured to determine a location of the electronic device. The computing system is configured to display one or more commercial rewards based on the quantity of the at least one selection of the at least one object of the one or more objects within the image from the at least one other electronic device of the one or more other electronic devices, and the location of the electronic device.

In an eleventh embodiment, the disclosure provides a method implemented by a computing system of an electronic device. The method includes receiving, by the computing system, a selection of at least a first object of one or more objects within an image. The method also includes transmitting, by the computing system, the image to one or more other electronic devices for display in response to receiving the selection of at least the first object. When the image is transmitted to the one or more other electronic devices for display, the image includes an indication that the computing system has received the selection of at least the first object. The method further includes identifying, by the computing system, a quantity of at least one selection of at least one object of the one or more objects within the image from at least one other electronic device of the one or more other electronic devices after the image is transmitted to the one or more other electronic devices for display. In addition, the method includes determining, by the computing system, a location of the electronic device. The method includes displaying, by the computing system, one or more commercial rewards based on the quantity of the at least one selection of the at least one object of the one or more objects within the image from the at least one other electronic device of the one or more other electronic devices, and the location of the electronic device.

In a twelfth embodiment, the disclosure provides a non-transitory, computer-readable storage medium. The non-transitory, computer-readable storage medium stores one or more executable instructions that, when executed by at least one processor, causes the at least one processor to receive a selection of at least a first object of one or more objects within an image. The one or more executable instructions that, when executed by at least one processor, also cause the at least one processor to transmit the image to one or more other electronic devices for display in response to receiving the selection of at least the first object. When the image is transmitted to the one or more other electronic devices for display, the image includes an indication that the at least one processor has received the selection of at least the first object. The one or more executable instructions that, when executed by at least one processor, further cause the at least one processor to identify a quantity of at least one selection of at least one object of the one or more objects within the image from at least one other electronic device of the one or more other electronic devices after the image is transmitted to the one or more other electronic devices for display. In addition, the one or more executable instructions that, when executed by at least one processor, cause the at least one processor to determine a location of the at least one processor. The one or more executable instructions that, when executed by at least one processor, cause the at least one processor to display one or more commercial rewards based on the quantity of the at least one selection of the at least one object of the one or more objects within the image from the at least one other electronic device of the one or more other electronic devices, and the location of the at least one processor.

In a thirteenth embodiment, the disclosure provides an electronic device including a computing system. The computing system includes a memory and at least one processor. The computing system is configured to receive a selection of an image of one or more objects. The computing system is also configured to transmit the image to one or more other electronic devices for display in response to receiving the selection of the image. When the image is transmitted to the one or more other electronic devices for display, the image includes an indication that the computing system has received the selection of the image. The computing system is further configured to identify a quantity of at least one selection of at least one object of the one or more objects within the image from at least one other electronic device of the one or more other electronic devices after the image is transmitted to the one or more other electronic devices for display. In addition, the computing system is configured to determine a location of the electronic device. The computing system is configured to display one or more commercial rewards based on the quantity of the at least one selection of the at least one object of the one or more objects within the image from the at least one other electronic device of the one or more other electronic devices, and the location of the electronic device.

In a fourteenth embodiment, the disclosure provides a method implemented by a computing system of an electronic device. The method includes receiving, by the computing system, a selection of an image of one or more objects. The method also includes transmitting, by the computing system, the image to one or more other electronic devices for display in response to receiving the selection of the image. When the image is transmitted to the one or more other electronic devices for display, the image includes an indication that the computing system has received the selection of the image. The method further includes identifying, by the computing system, a quantity of at least one selection of at least one object of the one or more objects within the image from at least one other electronic device of the one or more other electronic devices after the image is transmitted to the one or more other electronic devices for display. In addition, the method includes determining, by the computing system, a location of the electronic device. The method includes displaying, by the computing system, one or more commercial rewards based on the quantity of the at least one selection of the at least one object of the one or more objects within the image from the at least one other electronic device of the one or more other electronic devices, and the location of the electronic device.

In a fifteenth embodiment, the disclosure provides a non-transitory, computer-readable storage medium. The non-transitory, computer-readable storage medium stores one or more executable instructions that, when executed by at least one processor, causes the at least one processor to receive a selection of an image of one or more objects. The one or more executable instructions that, when executed by at least one processor, also cause the at least one processor to transmit the image to one or more other electronic devices for display in response to receiving the selection of the image. When the image is transmitted to the one or more other electronic devices for display, the image includes an indication that the at least one processor has received the selection of the image. The one or more executable instructions that, when executed by at least one processor, further cause the at least one processor to identify a quantity of at least one selection of at least one object of the one or more objects within the image from at least one other electronic device of the one or more other electronic devices after the image is transmitted to the one or more other electronic devices for display. In addition, the one or more executable instructions that, when executed by at least one processor, cause the at least one processor to determine a location of the at least one processor. The one or more executable instructions that, when executed by at least one processor, cause the at least one processor to display one or more commercial rewards based on the quantity of the at least one selection of the at least one object of the one or more objects within the image from the at least one other electronic device of the one or more other electronic devices, and the location of the at least one processor.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As another example, “at least one of: A, B, or C” includes any of the following combinations: A, B, C, A and B, A and C, B and C, and A and B and C.

Moreover, various functions described below can be implemented or supported by one or more computer programs, each of which is formed from computer readable program code and embodied in a computer readable storage medium. The terms “application” and “program” refer to one or more computer programs, software components, sets of instructions, procedures, functions, objects, classes, instances, related data, or a portion thereof adapted for implementation in a suitable computer readable program code. The phrases “computer readable program code” and “executable instruction” includes any type of computer code, including source code, object code, and executable code. The phrase “computer readable medium” and “computer-readable storage medium” includes any type of medium capable of being accessed by a computer or a processor, such as read only memory (ROM), random access memory (RAM), a hard disk drive, a compact disc (CD), a digital video disc (DVD), or any other type of memory. A “non-transitory” computer-readable medium and a “non-transitory” computer-readable storage medium exclude wired, wireless, optical, or other communication links that transport transitory electrical signals or other signals. A non-transitory, computer-readable medium and a non-transitory, computer-readable storage medium include media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a non-limiting, example network context for operating an electronic device according to certain embodiments of this disclosure;

FIG. 2 illustrates a non-limiting, example computing system configured to perform one or more interactive dynamic product display operations according to certain embodiments of this disclosure;

FIG. 3 illustrates a non-limiting, example user interface login display according to certain embodiments of this disclosure;

FIG. 4 illustrates a non-limiting, example of an image of one or more objects displayed on a display screen associated with an electronic device having a computing system performing one or more interactive dynamic product display operations according to certain embodiments of this disclosure;

FIG. 5 illustrates another non-limiting, example network context for operating an electronic device according to certain embodiments of this disclosure;

FIG. 6 illustrates a non-limiting, example social media platform display according to certain embodiments of this disclosure;

FIGS. 7-11 illustrate flow diagrams of methods for performing one or more interactive dynamic product display operations according to certain embodiments of this disclosure; and

FIG. 12 illustrates a non-limiting, example computer system configured to implement aspects of apparatuses, systems, and methods according to certain embodiments of this disclosure.

### DETAILED DESCRIPTION

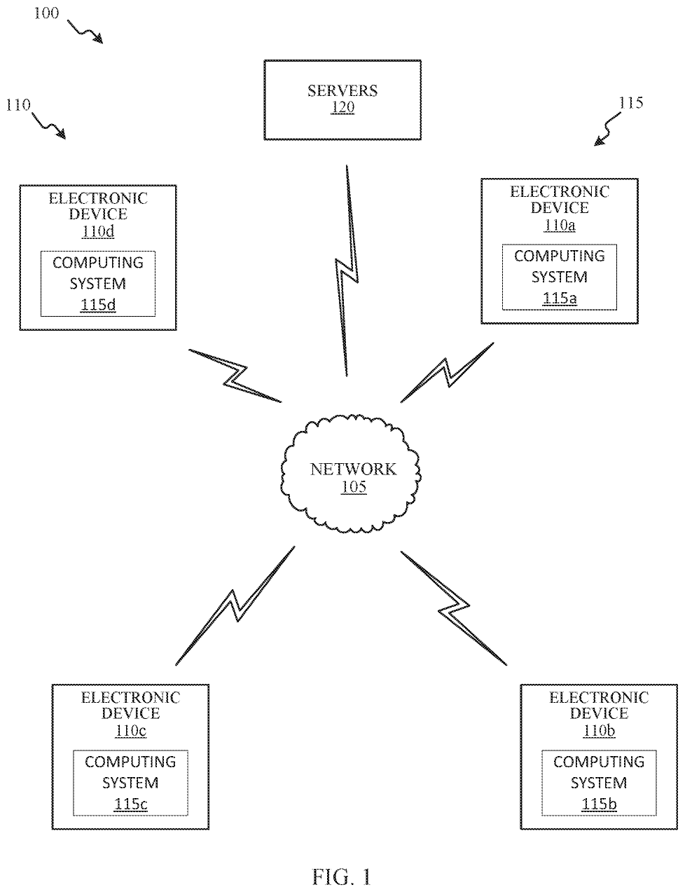

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

FIG. 1 illustrates a non-limiting, example network context 100 for operating one or more electronic device 110 according to certain embodiments of this disclosure. One or more components of the network context 100 may operate as separate components linked by one or more constituent networks of the network 105. In some embodiments, one or more constituent networks of the network 105 may include the internet, which can be accessed over both wired connections (e.g., an Ethernet connection) or over a wireless connection (e.g., a wireless local area network “WLAN” connection, a cellular network connection). Additionally, or alternatively, one or more constituent networks of the network 105 may include a combination of private networks (e.g., a local wireless mesh network) and public networks (e.g., a telephone (POTS) network). In certain embodiments, one or more constituent networks of the network 105 may support multiple communication protocols, including both wireless protocols (e.g., BLUETOOTH™, circuit-switched cellular, 3G, LTE, WiBro) and internet protocols (e.g., HTTP).

The one or more constituent networks of the network 105 provide two-way electronic connectivity (e.g., electronic communication) between each of the electronic devices 110 and the one or more servers 120. In certain embodiments, the one or more constituent networks of the network 105 provide two-way electronic connectivity between each of the electronic devices 110 and the one or more servers 120 using one or more same or different channels, protocols, or networks of network 105. For example, a circuit-switched cellular protocol wireless network of the network 105 provides electronic connectivity between the first electronic device 110a and the one or more servers 120 while a POTS wireless network of the network 105 provides electronic connectivity between the third electronic device 110c and the one or more servers 120.

In certain embodiments, the network context 100 may, according to certain embodiments, include one or more servers 120. In certain embodiments, the one or more servers 120 stores user profiles that each may include at least one of a user name, user contact information, one or more images that have received a selection through an electronic device associated with the user profile, one or more objects within one or more images that have received a selection through an electronic device associated with the user profile, a history of a quantity of images that have been selected, a history of a quantity of objects within images have been selected, a history of a frequency of image selection, a history of a frequency of object selections within images, a duration that the user profile has been in existence, a duration that the user profile has been active, a duration that the user profile has been inactive, a quantity of electronic devices that have received an image from an electronic device associated with the user profile, a quantity of electronic devices that have received one or more images from an electronic device associated with the user profile and that have received a selection of a received image, a quantity of electronic devices that have received one or more images from an electronic device associated with the user profile and that have received a selection of at least one object within the received image, a quantity of selections of one or more images received by one or more electronic devices that received images from an electronic device associated with the user profile, a quantity of selections of one or more objects within images received by one or more electronic devices that received images from an electronic device associated with the user profile, one or more characteristics of images or objects selected by an electronic device associated with the user profile, or the like.

The one or more servers 120 may also store producer profiles that each include at least one of a producer name, one or more physical locations where the producer sells one or more products, one or more virtual locations where the producer sells one or more products, one or more commercial rewards associated with a producer's product displayed as an object within an image, or the like. The one or more servers 120 may further store product profiles that each include at least one of a product name, a product type, a product size (e.g., one or more dimensions), a product material, a product color, a product style, a producer associated with the product, one or more physical locations where the product is sold, one or more virtual locations where the product is sold, one or more images where a product is displayed, one or more commercial rewards associated with the product displayed as an object within an image, or the like.

In certain embodiments, the network context 100 includes one or more electronic devices 110. The one or more electronic devices 110 may include a first electronic device 110a, a second electronic device 110b, a third electronic device 110c, and a fourth electronic device 110d. In certain embodiments, each of the one or more electronic devices 110 is configured to communicate data with the one or more servers 120 through the network 105. In certain embodiments, each of the one or more electronic devices 110 is configured to execute one or more interactive dynamic product display operations described herein. In certain embodiments, each of the electronic devices 110 includes an electronic device display screen (e.g., a touch-screen), an electronic device memory, and one or more electronic device processors. The electronic devices 110 may be any of various types of devices, including, but not limited to, a computer embedded in an appliance, a personal computer system, a desktop computer, a handset, a laptop computer, a notebook computer, a tablet, a slate, a netbook computer, a handheld computer, a consumer device, a portable storage device, a mainframe computer system, a workstation, network computer, a mobile device, a storage device, a peripheral device such as a switch, modem, router, or in general any type of electronic computing device.

In certain embodiments, each of the one or more electronic devices 110 includes a computing system 115. For example, the first electronic device 110a includes a first computing system 115a, the second electronic device 110b includes a second computing system 115b, the third electronic device 110c includes a third computing system 115c, and the fourth electronic device 110d includes a fourth computing system 115d. Each of the computing systems 115 may include an electronic device memory and one or more electronic device processors to execute one or more interactive dynamic product display operations discussed herein.

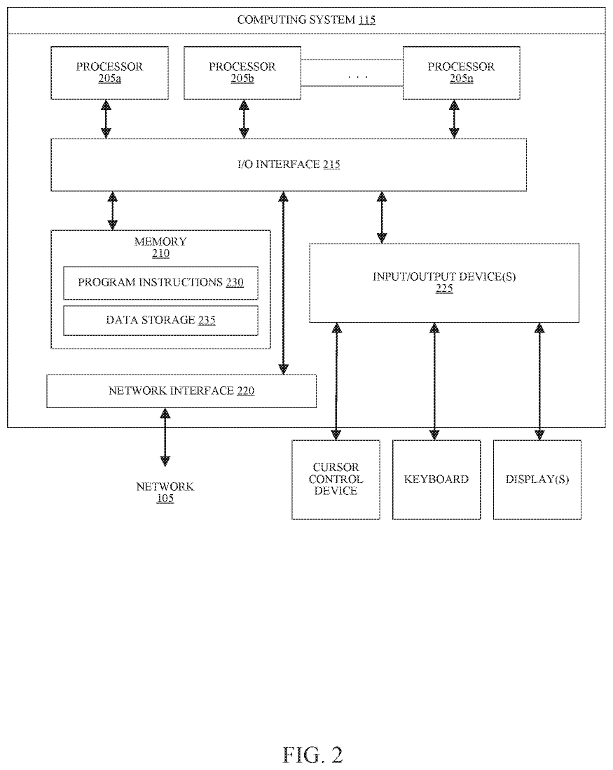

FIG. 2 illustrates a non-limiting, example of a computing system 115 illustrated in FIG. 1. The computing system 115 is configured to execute any and all of the embodiments and operations described herein including embodiments for performing one or more interactive dynamic product display operations. In certain embodiments, the computing system 115 may perform one or more interactive dynamic product display operations using the network 105 to receive a selection of an image of one or more objects, transmit the image to one or more other electronic devices for display after (e.g., in response to) receiving the selection of the image, where, when the image is transmitted to the one or more other electronic devices for display, the image includes an indication that the computing system has received the selection of the image, identify a quantity of at least one other electronic device of the one or more other electronic devices that receives a selection of the image after the image is transmitted to the one or more other electronic devices for display, determine a location of the electronic device, and display one or more commercial rewards based on the quantity of the at least one other electronic device of the one or more other electronic devices that receives the selection of the image and the location of the electronic device. In different embodiments, the computing system 115 may be any of various types of devices, including, but not limited to, a computer embedded in an appliance, a personal computer system, a desktop computer, a handset, a laptop computer, a notebook computer, a tablet, a slate, a netbook computer, a handheld computer, a consumer device, a portable storage device, a mainframe computer system, a workstation, network computer, a mobile device, an application server, a storage device, a peripheral device such as a switch, modem, router, or in general any type of electronic computing device.

Various embodiments of a system and method for interactive dynamic product display operations, as described herein, may be executed on one or more computing systems 115, which may interact with various other devices. In the illustrated embodiment, the computing system 115 may include one or more processors 205a, 205b, . . . , and 205n (hereinafter “one or more processors 205,” “processors 205,” or “processor 205”) coupled to a memory 210 via an input/output (I/O) interface 215. The computing system 115 may further include a network interface 220 coupled to I/O interface 215, and one or more input/output devices 225, such as cursor control device of the electronic device 110, a keyboard of the electronic device 110, and one or more displays of the electronic device 110. In some cases, it is contemplated that embodiments may be implemented using a single instance of the computing system 115, while in other embodiments multiple such systems, or multiple nodes making up the computing system 115, may be configured to host different portions or instances of embodiments. For example, in one embodiment some elements may be implemented via one or more nodes of the computing system 115 that are distinct from those nodes implementing other elements.

In various embodiments, the computing system 115 may be a uniprocessor system including one processor 205a, or a multiprocessor system including several processors 205a-205n (e.g., two, four, five, eight, or another suitable number). The processor 205 may be any suitable processor capable of executing instructions or operations including interactive dynamic product display operations described herein. For example, in various embodiments the processor 205 may be a general-purpose or embedded processor implementing any of a variety of instruction set architectures (ISAs), such as the x86, PowerPC, SPARC, or MIPS ISAs, or any other suitable ISA. In multiprocessor systems, each of processors 205 may commonly, but not necessarily, implement the same ISA.

The memory 210 may be configured to store the executable instructions or program instructions 230 in the data storage 235 accessible by the processor 205. In various embodiments, the memory 210 may be implemented using any suitable memory technology, such as static random access memory (SRAM), synchronous dynamic RAM (SDRAM), nonvolatile/Flash-type memory, or any other type of memory. In the illustrated embodiment, the program instructions 230 may be configured to implement a system for interactive dynamic product display operations incorporating any of the functionality described herein. In some embodiments, program instructions 230 or data may be received, sent, or stored upon different types of computer-accessible media or on similar media separate from the memory 210 or the computing system 115. The computing system 115 is described as implementing at least some of the functionality of functional blocks in the figures described herein.

In certain embodiments, the I/O interface 215 may be configured to coordinate I/O traffic between the processor 205, the memory 210, and any peripheral devices of the computing system 115, including the network interface 220 or other peripheral interfaces, such as the input/output devices 225. In some embodiments, the I/O interface 215 may perform any necessary protocol, timing, or other data transformations to convert data signals from one component (e.g., the memory 210) into a format suitable for use by another component (e.g., the processor 205). In some embodiments, the I/O interface 215 may include support for devices attached through various types of peripheral buses, such as a variant of the Peripheral Component Interconnect (PCI) bus standard or the Universal Serial Bus (USB) standard, for example. In some embodiments, the function of the I/O interface 215 may be split into two or more separate components, such as a north bridge and a south bridge, for example. Also, in some embodiments some or all of the functionality of the I/O interface 215, such as an interface to the memory 210, may be incorporated directly into the processor 205.

The network interface 220 may be configured to allow data to be exchanged between the computing system 115 and other devices attached to the network 105 (e.g., one or more servers 120) or between nodes of the computing system 115. The network 105 may in various embodiments include one or more networks including but not limited to Local Area Networks (LANs) (e.g., an Ethernet or corporate network), Wide Area Networks (WANs) (e.g., the Internet), wireless data networks, some other electronic data network, a combination thereof, or the like. In various embodiments, the network interface 220 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network or protocol.

The input/output devices 225 may, in some embodiments, include one or more display terminals, keyboards, keypads, touchpads, scanning devices, voice, or optical recognition devices, or any other devices suitable for entering or accessing data by one or more computing systems 115. Further, various other sensors may be included in the I/O devices 225, such as imaging sensors, barometers, altimeters, LIDAR, or any suitable environmental sensor. Multiple input/output devices 225 may be present in the computing system 115 or may be distributed on various nodes of the computing system 115. In some embodiments, similar input/output devices may be separate from the computing system 115 and may interact with one or more nodes of the computing system 115 through a wired or wireless connection, such as over the network interface 220.

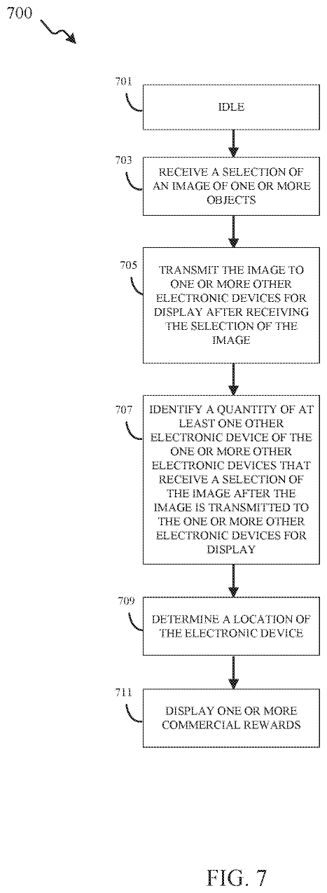

As shown in FIG. 2, the memory 210 may include program instructions 230, which may be processor-executable to implement any element, action, or operation including interactive dynamic product display operations, as described herein. In certain embodiments, the program instructions may implement at least a portion of methods described herein, such as the methods illustrated by FIGS. 7-11. In other embodiments, different elements and data may be included. Note that the data storage 235 may include any data or information including data or information described herein.

Those skilled in the art will appreciate that the computing system 115 is merely illustrative and is not intended to limit the scope of embodiments. In particular, the computing system 115 and devices may include any combination of hardware or software that can perform the indicated functions, including computers, network devices, Internet appliances, PDAs, wireless phones, pagers, GPUs, specialized computer systems, information handling apparatuses, or the like. The computing system 115 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on a storage medium while being used, these items or portions of them may be transferred between a memory and other storage devices for purposes of memory management and data integrity. Alternatively, in other embodiments some or all of the software components may execute in memory on another device and communicate with the illustrated computing system 115 via inter-computer communication. Some or all of the system components or data structures may also be stored (e.g., as instructions or structured data) on a computer-accessible medium or a portable article to be read by an appropriate drive, various examples of which are described here. In some embodiments, instructions stored on a computer-accessible medium separate from the computing system 115 may be transmitted to the computing system 115 through transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, or the like), ROM, or the like. In some embodiments, a computer-accessible medium may include transmission media or signals such as electrical, electromagnetic, or digital signals, conveyed via a communication medium such as network and/or a wireless link.

As described herein, the computing system 115, utilizing the at least one processor 205, is configured to execute one or more interactive dynamic product display operations. In certain embodiments, the computing system 115, utilizing one or more processors 205, generates an interface login display for display on a display screen. The interface login display may be used to set up a new user profile or login into an existing user profile to pay for and participate in promotions as described herein.

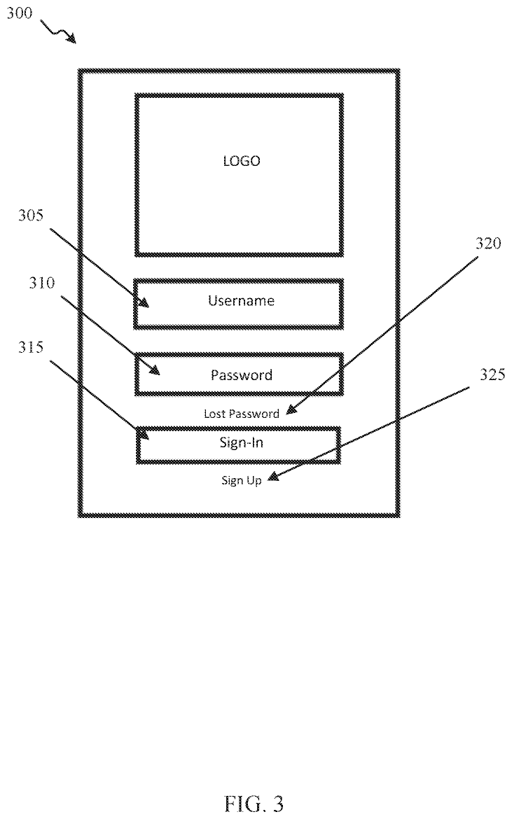

FIG. 3 illustrates a non-limiting, example user interface login display 300 according to certain embodiments of the disclosure. As shown in FIG. 3, the user interface login display 300 may include a username field 305, a password field 310, and a sign-in selection button 315. For example, a user may have previously initiated the computing system 115 to execute one or more interactive dynamic product display operations. The computing system 115 may generate the interface login display 300 for display on a display screen. After displaying the user interface login display 300, the computing system 115 may receive a selection of a sign-up selection button 325. Upon receiving the selection of the sign-up selection button 325, the computing system 115 may generate for display a display screen to generate a user profile for a user. The computing system 115 may receive a username (e.g., an email address) to identify the user profile and a password to provide security to the user profile. Subsequently, a user may initiate the computing system 115 to execute one or more interactive dynamic product display operations causing the computing system 115 to generate the user interface login display 300.

After displaying the user interface login display 300, the computing system 115 may receive a username (e.g., an email address) identifying the user profile in the username field 305 and a password in the password field 310 to gain access to the user profile. After receiving the username and the password, the computing system 115 may receive a selection of the sign-in selection button 315 to access the user profile. In certain embodiments, the computing system 115 may receive a selection of the lost password selection button 320. Upon receiving the selection of lost password selection button 320, the computing system 115 may guide the user using one or more displays through one or more password recovery or password reset procedures to securely gain access to the user profile.

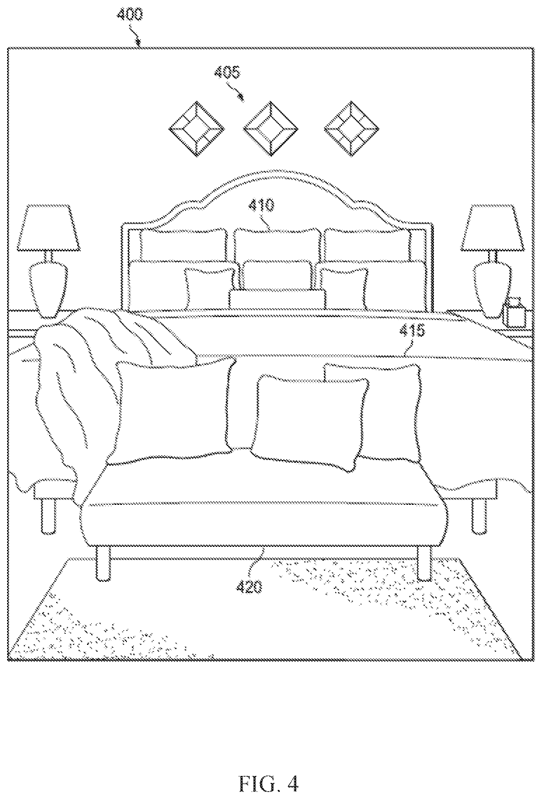

The computing system 115 of an electronic device 110, performing one or more interactive dynamic product display operations, is configured to receive a selection of an image of one or more objects. For example, the computing system 115 may generate for display an image of one or more object and display the image on a display screen of the electronic device 110. FIG. 4 illustrates a non-limiting, example of an image 400 of one or more objects displayed on a display screen of an electronic device 110 performing one or more interactive dynamic product display operations according to certain embodiments of this disclosure. The image 400 may have been created by a user logged into their user account for posting the image 400 on one or more social media websites or social media platforms (hereinafter “social media platforms”) (e.g., FACEBOOK™, PINTREST™, WHATSIT™, INSTAGRAM™, a social media platform associated with the user interface login display 300) or the image 400 may have been copied from one or more webpages and placed into the user account for posting the image 400 on the one or more social media platforms. The image 400 may contain one or more objects 405 arranged in a decorative fashion for a viewer to see how each object may be arranged for display amongst other objects. In certain embodiments, the one or more objects 405 may include at least one of a furniture piece, a decorative item, a furniture piece accessory, an article of clothing, a clothing accessory, or the like. As shown in FIG. 4, the one or more objects 405 may include a decorative pillow set 410, a comforter 415, and ottoman 420.

At least one object of the one or more objects 405 may include a product that is sold by one or more producers. For example, the decorative pillow set 410 may be sold directly by a manufacturer both online and through one or more manufacturer direct brick-and-mortar locations. The comforter 415 may be sold at one or more retail stores both online and through brick-and-mortar locations. The ottoman 420 may be sold at only one or more brick-and-mortar retail store locations.

The image 400 may have a marker that is associated with every object within the image 400 or with the image itself. For example, when the image 400 is placed into the user account for posting the image 400 to the one or more social media platforms, the image 400 may be marked with a marker. The marker may be inserted into or with the image 400 (e.g., on a region of the image, on the entire image, or through a selection button associated with the image). In certain embodiments, the marker may include a symbol (e.g., a pictorial symbol, an alpha-numeric character sequence) displayed on the image 400. Additionally, or alternatively, the marker may include an invisible or shaded region on the image 400. The marker for the image 400 may be selectable. For example, after the image 400 is marked with a marker, the marker may be selected through at least one of a touch-input on the location of the marker, through a movement and click of a cursor on the location of the marker, through a selection window listing the marker and the associated image 400, or the like. The computing system 115 of the electronic device 110 may receive a selection of a marker through a display screen or through a user input interface and interpret the selection of the marker as a selection of the image 400 associated with the marker. A received selection of an image may be indicative of an interest that a user viewing the image 400 has in an object within the image, the arrangement of the objects within the image, the image itself, or the like.

Additionally, or alternatively, each of the one or more objects 405 within the image 400 may include a marker. For example, when the image 400 is placed into the user account for posting the image 400 to the one or more social media platforms, each of the one or more objects 405 may be marked with a marker. The marker may be inserted into the image 400 at the location of the object. In certain embodiments, the marker may include a symbol (e.g., a pictorial symbol, an alpha-numeric character sequence) displayed on the object in the image 400. Additionally, or alternatively, the marker may include an invisible or shaded region within the location of the object in the image 400. Each of the one or more markers may be selectable. For example, after one or more objects within the image 400 are marked with a marker, at least one marker of the one or more markers may be selected through at least one of a touch-input on the location of the marker in the image 400 on the display screen, through a movement and click of a cursor on the location of the marker in the image 400 on the display screen, through a selection window listing the one or more markers displayed on each of the one or more objects in the image 400 on the display screen, or the like. The computing system 115 of the electronic device 110 may receive a selection of a marker through a display screen or through a user input interface and interpret the selection of the marker as a selection of the object associated with the marker. A received selection of an object may be indicative of an interest that a user viewing the image has in the selected object or in an arrangement of the selected object with one or more other objects within image.

The image 400 may include image information. For example, when the image 400 is marked with a marker, image information associated with the image 400 may be provided to the computing system 115 through a user interface (e.g., a user interface image information input screen). The image information for the image 400 may be stored in an embedded electronic file with the image 400 or may be included in the image itself (e.g., for viewing on the image) so that when the image 400 is transmitted to another electronic device, the image information for the image 400 may be accessed and viewed through a display window on a display screen or on the image itself. Additionally, or alternatively, the image information for the image 400 may be stored in an embedded electronic file with the image 400 so that when the image 400 is transmitted to the one or more servers 120, the image information for the image 400 may be stored in an image profile associated with the image 400, a user profile associated with a user, or a producer file associated with a producer of the image or at least one object within the image 400. Image information may include at least one of a source of the image, one or more brands associated with the image, one or more brick-and-mortar stores (e.g., retail stores, factory direct stores) associated with the image, or the like.

Additionally, or alternatively, each of the one or more objects 405 within the image 400 may include object information. For example, when each of the one or more objects 405 is marked with a marker, object information associated with each marked object may be provided to the computing system 115 through a user interface (e.g., a user interface object information input screen). The object information for each marked object may be stored in an embedded electronic file with the image 400 or may be included in the image itself (e.g., for viewing on the image) so that when the image 400 is transmitted to another electronic device, the object information for each object may be accessed and viewed through a display window on a display screen or on the image itself. Additionally, or alternatively, the object information for each marked object may be stored in an embedded electronic file with the image 400 so that when the image 400 is transmitted to the one or more servers 120, the object information for each object may be stored in at least one of an image profile associated with the image 400, a user profile associated with a user, a producer file associated with a producers of the image 400, or a producer file associated with a producer of at least one object within the image 400. Object information may include at least one of an object name, an object type, an object characteristic, an object price, an object color, one or more object dimensions, an object material, an object brand, an object manufacturer, one or more brick-and-mortar stores that sell the object, a location of one or more brick-and-mortar stores that sell the object, one or more brick-and-mortar stores that sell related objects, a location of one or more brick-and-mortar stores that sell related objects, or the like.

The computing system 115 of an electronic device 110, performing one or more interactive dynamic product display operations, is configured to transmit the image to one or more other electronic devices for display after (e.g., in response to) receiving the selection of the image. For example, after the image 400 is displayed on a display screen and the computing system 115 of the electronic device 110 receives a selection of at least one of the image 400 or one or more objects within the image 400, the computing system 115 may transmit the image 400 to one or more other electronic devices. In certain embodiments, the computing system 115 may transmit the image to one or more other electronic devices through SMS messaging communication, email communication, direct near field communication (NFC), or the like. For example, a memory of the electronic device 110 may store one or more contacts containing at least one of a mobile phone number or an email address associated with each of the one or more contacts. After the image 400 is displayed on a display screen and the computing system 115 of the electronic device 110 receives a selection of at least one of the image 400 or one or more objects within the image 400, the computing system 115 may transmit the image 400 to one or more other electronic devices via SMS communication using the mobile phone numbers stored in the one or more contacts, via email communication using the email addresses stored in the one or more contacts, or via NFC using detected transmitters of the one or more other electronic devices.

In certain embodiments, the computing system 115 may transmit the image 400 to one or more other electronic devices 110 through one or more social media platforms. For example, a user of a user profile may have a user account with one or more social media platforms. On each social media platform, the user account may share information (e.g., pictures, videos, text) with one or more user account approved contacts. The user accounts for each of the one or more social media platforms may also be linked or associated with the user profile associated with the interactive dynamic product display operations. After the image 400 is displayed on a display screen and the computing system 115 of the electronic device 110 receives a selection of at least one of the image 400 or one or more objects within the image 400, the computing system 115, performing one or more interactive dynamic product display operations, may generate for display a social media platform selection menu. The social media platform selection menu may include one or more selections to transmit the image 400 to other electronic devices 110 through one or more social media platforms. After receiving a selection of one or more social media platforms, the computing system 115 may access the user account associated with the user profile for each of the selected one or more social media platforms and transmit the image 400 through the user accounts of each of the social media platforms to other electronic devices that are used by the contacts associated with the user accounts of each of the social media platforms. In certain embodiments, a selected image or an image with a selected object may be viewed by anyone permitted to view content provided by the user account through the social media platforms.

In certain embodiments, when the computing system 115 transmits the image 400 to the one or more other electronic devices, the image 400 may include an indication that the computing system 115 has received a selection of at least one of the image 400 or one or more objects within the image 400. For example, when the computing system 115 transmits the image 400 to one or more other electronic devices through an electronic communication (e.g., SMS messaging communication, email communication, NFC, one or more social media platforms), the transmitted image 400 may contain an indication that at least one of the transmitted image 400 or one or more objects within the transmitted image 400 received a selection. When each of the one or more other electronic devices receives the transmitted image 400 and displays the transmitted image 400 on a display screen, the indication that the computing system 115 has received a selection of at least one of the image 400 or one or more objects within the image 400 may be displayed when the transmitted image 400 is displayed by each of the one or more other electronic devices. The indication that the computing system 115 has received a selection of at least one of the image 400 or one or more objects within the image 400 may inform the viewer viewing a display screen of at least one of the one or more other electronic devices that a viewer (e.g., a view associated with a user profile) associated with the computing system 115 may have a particular interest in the selected image 400 or one or more selected objects within the image 400. In certain embodiments, when the transmitted image 400 contains an indication that the image 400 received a selection, the indication may indicate that the transmitted image 400 received the selection. Additionally, or alternatively, when the transmitted image 400 contains an indication that one or more objects within the image 400 received a selection, the indication may indicate which objects within the image 400 received the selection.

The computing system 115 of an electronic device 110, utilizing the at least one processor 205 to execute one or more interactive dynamic product display operations, is configured to identify a quantity of at least one other electronic device of the one or more other electronic devices that receives a selection of the image after the image is transmitted to the one or more other electronic devices for display. For example, when the computing system 115 transmits the image 400 to the one or more other electronic devices, the computing system 115 may include an electronic tag with the image 400. The electronic tag may link the image 400 to the computing system 115 (e.g., the computing system 115 that transmitted the image 400, a user profile that transmitted the image 400 through the computing system 115). In certain embodiments, described herein, the electronic tag may include instructions for a processor of another electronic device that receives the transmitted image 400 from the computing system 115 of the electronic device 110 to generate a coupon or voucher on a display screen of the other electronic device when the other electronic device receives a selection of the transmitted image 400 or a selection of one or more objects within the transmitted image 400.

In certain embodiments, the electronic tag may provide instructions to each of the other electronic devices to detect when the other electronic devices receive a selection of the image 400 or a selection of one or more objects within the image 400. When a processor of another electronic device displaying the transmitted image 400 detects the reception of a selection of the image 400 or one or more objects within the image 400, the processor of the other electronic device, through the instructions from the electronic tag, may transmit a selection indication to at least one of the one or more servers 120 or the electronic device 110. The selection indication may include an indication that the image 400 or one or more objects within the image 400 were selected, and when one or more objects within the image 400 are selected, identify which one or more objects within the image 400 were selected. The selection indication may also include an identification of the computing system 115 that transmitted the image 400 (e.g., a user profile that transmitted the image 400 through the computing system 115) to the other electronic device. When the computing system 115 of the electronic device 110 receives the selection indication, the computing system 115 may store the selection indication in a data store with one or more other selection indications associated with the image 400 or associated with an object within the image 400. The computing system 115 may identify a quantity of other electronic devices that receive a selection of the image or a quantity of other electronic devices that receive a selection of a particular object within the image 400 using the stored selection indications.

In certain embodiments, when the one or more servers 120 receive the selection indication, the one or more servers 120 may store the selection indication with one or more other selection indications associated with the image 400. The one or more servers 120 may identify a quantity of other electronic devices that receive a selection of the image 400 or a quantity of other electronic devices that receive a selection of a particular object within the image 400 using the stored selection indications. The one or more servers 120 may transmit the quantity of other electronic devices that receive a selection of the image or the quantity of other electronic devices that receive a selection of a particular object within the image 400 to the computing system 115 of the electronic device 110.

The computing system 115 of an electronic device 110, utilizing the at least one processor 205 to execute one or more interactive dynamic product display operations, is configured to determine a location of the electronic device 110. In certain embodiments, the computing system 115 may utilize a global positioning system (GPS), triangulation between two or more base stations, an accelerometer, NFC, a combination thereof, or the like to determine a location of the electronic device. The computing system 115 may determine GPS coordinates of the electronic device 110, an address of the electronic device 110, a location of the electronic device 110 relative to another location, or the like. For example, the computing system 115 may determine that the electronic device 110 is located at a residence associated with a user profile that is being accessed through the electronic device 110. As another example, the computing system 115 may determine that the electronic device 110 is located within a brick-and-mortar store selling one or more items displayed as objects in an image transmitted by the computing system 115 (e.g., the user profile associated with the computing system 115). As yet another example, the computing system 115 may determine that the electronic device 110 is located immediately outside or within a distance of a brick-and-mortar store selling one or more items displayed as objects in an image transmitted by the computing system 115. As another example, the computing system 115 may determine that the electronic device 110 is being transported in a direction towards a brick-and-mortar store selling one or more items displayed as objects in an image transmitted by the computing system 115. As yet another example, the computing system 115 may determine the location of the electronic device 110 to provide a distance between the location of the electronic device 110 and one or more brick-and-mortar stores selling one or more items displayed as objects in an image transmitted by the computing system 115. As another example, the computing system 115 may determine the location of the electronic device 110 to provide directions from the location of the electronic device 110 to one or more brick-and-mortar stores selling one or more items displayed as objects in an image transmitted by the computing system 115. As described herein, the computing system 115 may determine a location of the electronic device 110 to display one or more commercial rewards on a display screen of the electronic device 110.

The computing system 115 of an electronic device 110, utilizing the at least one processor 205 to execute one or more interactive dynamic product display operations, is configured to display one or more commercial rewards on a display screen associated with the electronic device 110. Commercial rewards may be rewards electronically provided to an electronic device 110 (e.g., an electronic device associated with a user profile) that provide an incentive to a user associated with the electronic device (e.g., a user profile associated with the electronic device 110) to purchase an item. A commercial reward may include at least one of a discount sales price for one or more objects within a transmitted image, a discount sales price for an object within a transmitted image 400 that was selected by a largest quantity of electronic devices of the one or more other electronic devices, a discount sales price for an object within a transmitted image 400 that was selected by a quantity of electronic devices of the one or more other electronic devices that is above a threshold quantity, a discount sales price for at least one object of the one or more objects within the transmitted image that received a selection, a discount sales price for one or more items for sale by one or more sources (e.g., a brick-and-mortar store, an electronic store) that sell at least one object of the one or more objects within the transmitted image, a voucher for a promotional item from one or more manufacturers or retail stores that are associated with the transmitted image or at least one object of the one or more objects within the transmitted image, a voucher to receive a monetary sum from a manufacturer or a retail store that is associated with an object of the one or more objects within the transmitted image, a voucher to receive an object of the one or more objects within the transmitted image from a manufacturer or a retail store that is associated with the transmitted image, or the like.

In certain embodiments, the computing system 115 of the electronic device 100 displays one or more commercial rewards based on a quantity of other electronic devices that receive a selection of a transmitted image or a quantity of other electronic devices that receive a selection of a particular object within a transmitted image. For example, the computing system 115 may receive a selection of the image 400 displayed on a display screen (e.g., a display screen of the electronic device 110, a display screen in electronic communication with the computing system 115). The computing system 115 may transmit the image 400 including the indication that the computing system 115 of the electronic device 110 (e.g., a user profile associated with the electronic device 110) received a selection of the image 400 to one or more other electronic devices through a social media platform. Each of the one or more other electronic devices may be associated with a user account that is in contact with or able to view content from the user account of the electronic device 115. At least one of the one or more other electronic devices may receive a selection of the image 400 or a selection of particular one or more objects within the image 400 and transmit the selection to at least one of the one or more servers 120 or the computing system 115 of the electronic device 110. The computing system 115 may receive each of the selections from the at least one other electronic device of the one or more other electronic devices and determine or identify a quantity of other electronic devices of the one or more other electronic devices that received a selection of the image 400 or a selection of one or more particular objects within the image 400.

The computing system 115 may display (e.g., generate for display on a display screen) one or more commercial rewards based on a quantity of other electronic device that received a selection of the image 400 or one or more objects within the image 400. For example, the computing system 115 may generate, for display on a display screen of the electronic device 110, a commercial reward of a 5% discount for one or more products from a producer associated with the image 400 or one or more object within the image 400 when the quantity of other electronic devices that receive a selection of the image 400 transmitted from the electronic device (e.g., a user profile associated with the electronic device 110) is above a first threshold. As another example, the computing system 115 may generate, for display on a display screen of the electronic device 110, a commercial reward of a 10% discount for one or more products from a producer associated with the image 400 or one or more object within the image 400 when the quantity of other electronic devices that receive a selection of the image 400 transmitted from the electronic device (e.g., a user profile associated with the electronic device 110) is above a second threshold that is greater than the first threshold. As yet another example, the computing system 115 may generate, for display on a display screen of the electronic device 110, a commercial reward of a complimentary product and a 10% discount for one or more products from a producer associated with the image 400 or one or more object within the image 400 when the quantity of other electronic devices that receive a selection of the image 400 transmitted from the electronic device (e.g., a user profile associated with the electronic device 110) is above a third threshold that is greater than the second threshold.

Additionally, or alternatively, the computing system 115 may display (e.g., generate for display on a display screen) one or more commercial rewards based on a quantity of selections received of one or more objects within the image 400 from one or more other electronic devices that received the transmitted image 400. For example, the computing system 115 may generate, for display on a display screen of the electronic device 110, a commercial reward of a 5% discount for one or more products from a producer associated with at least one particular object within the image 400 when the quantity of selections received for one or more particular objects within the image 400 from one or more other electronic devices is above a first threshold. Another example, the computing system 115 may generate, for display on a display screen of the electronic device 110, a commercial reward of a 10% discount for one or more products from a producer associated with at least one particular object within the image 400 when the quantity of selections received for one or more particular objects within the image 400 from one or more other electronic devices is above a second threshold that is greater than the first threshold. As yet another example, the computing system 115 may generate, for display on a display screen of the electronic device 110, a commercial reward of a complimentary product and a 10% discount for one or more products from a producer associated with at least one particular object within the image 400 when the quantity of selections received for one or more particular objects within the image 400 from one or more other electronic devices is above a third threshold that is greater than the second threshold.

As described herein, the electronic tag included with the transmitted image 400 from the computing system 115 of the electronic device 110 may include instructions for a processor of another electronic device that receives the transmitted image 400 to generate a coupon or voucher on a display screen of the other electronic device when the other electronic device receives a selection of the transmitted image or a selection of one or more objects within the transmitted image 400. The coupon or voucher may provide a discount to the other electronic device (e.g., a user profile associated with the other electronic device) for purchasing an object in the image 400 selected by the other electronic device or a discount for purchasing an object selected by the other electronic device through the image 400.

In certain embodiments, the coupon or voucher may include a code (e.g., a bar code, an image, an alpha-numeric code) that may be provided to a producer to receive a discount when purchasing an object within the image 400. In some embodiments, the code may be a code that is unique to the computing system 115 of the electronic device 110 (e.g., a user profile associated with the computing system 115 of the electronic device 110) that transmitted the image 400 to the other electronic device and that is unique to the image 400 or one or more objects within the image 400. When the producer receives the code during a sale of an object within the image 400, the producer may attribute the sale of the object (and additionally, or alternatively, the sale of one or more additional items purchased with the sale of the object) to the computing system 115 of the electronic device 110 (e.g., the user profile associated with the computing system 115 of the electronic device 110) that transmitted the image 400 to the other electronic device based on the unique code. The producer may transmit a sale indication to the one or more servers 120 or the computing system 115 of the electronic device 110 including a sale price for the purchased object and a total sale price for an entire purchase that includes the sale price for the purchased object. The sale indication may also attribute the sale price for the purchased object and a total sale price for an entire purchase that includes the sale price for the purchased object to the computing system 115 of electronic device 110 (e.g., the user profile associated with the computing system 115 of the electronic device 110). The one or more servers 120 or the computing system 115 of the electronic device 110 may store an accumulating sales amount from each of one or more producers associated with one or more objects in one or more images and attribute the accumulating sales amount to the computing system 115 of the electronic device 110. When the attributed accumulating sales amount from a producer of one or more objects in an image reaches a threshold, the computing system 115 of the electronic device 110 may display a commercial reward that includes a voucher for a discount as described herein or monetary compensation (e.g., a commission).

In certain embodiments, the coupon or voucher may include a field to populate with a code (e.g., an alpha-numeric code) that is provided by a producer when the coupon or voucher is provided to the producer to receive a discount when purchasing an object within the image 400. The code may be a code that is unique to the object from the image 400 being purchased or to the transmitted image 400 containing the object being purchased. The code may also be indicative of the sales price for the purchased object or the total sales price for a group of items purchased with the purchased object from the image 400. When the field receives the code during or after a sale that includes an object within the image 400, the other electronic device may transmit a sales indication based on the code to at least one of the one or more server 120 or the computing system 115 of the electronic device 110. The sale indications may include a sale price for the purchased object and a total sale price for an entire purchase that includes the sale price for the purchased object. The sale indication may also attribute the sale price for the purchased object and a total sale price for an entire purchase that includes the sale price for the purchased object to the computing system 115 of electronic device 110 (e.g., the user profile associated with the computing system 115 of the electronic device 110). The one or more servers 120 or the computing system 115 of the electronic device 110 may store an accumulating sales amount from each of one or more producers associated with one or more objects in one or more images and attribute the accumulating sales amount to the computing system 115 of the electronic device 110. When the attributed accumulating sales amount from a producer of one or more objects in an image reaches a threshold, the computing system 115 of the electronic device 110 may display a commercial reward that includes a voucher for a discount as described herein or monetary compensation (e.g., a commission).

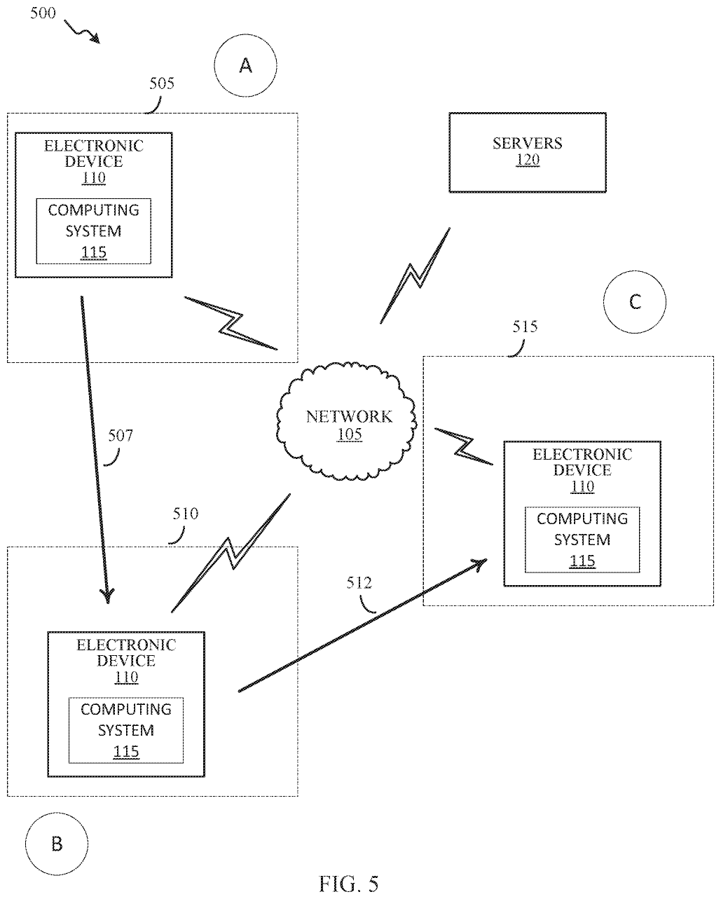

In certain embodiments, the computing system 115 of the electronic device 100 displays one or more commercial rewards based on the location of the electronic device. FIG. 5 illustrates another non-limiting, example network context 500 for operating an electronic device 110 according to certain embodiments of this disclosure. As shown in FIG. 5, the network context 500 includes the electronic device 110 including the computing system 115 at different stages or different instances in time. For example, at a first stage A, the electronic device 110 may be located at a first location 505 at a first time. At a second stage B, the electronic device 110 may be located at a second location 510 at a second time or subsequent time from the first time. The electronic device 110 may have been transported from the first location 505 to the second location 510 along the direction 507. The second location 510 may be a different location from the first location 505. At a third stage C, the electronic device 110 may be located at a third location 515 at a third time or a time that is subsequent to the first time and the second time. The electronic device 110 may have been transported from the second location 510 to the third location 515 along the direction 512. The third location 515 may be a different location from the first location 505 and the second location 510. In certain embodiments, the third location 515 may be a different location from the second location 510 and a same location as the first location 505.

At the first stage A, the computing system 115 of the electronic device 110 may determine that the electronic device 110 is located at the first location 505. In certain embodiments, the first location 505 may be any location other than the second location 510. In certain embodiments, the first location 505 may be a residence address indicated in a user profile that is attributed with an identified quantity of other electronic devices or an identified quantity of selections from one or more other electronic devices as described herein. In certain embodiments, the first location 505 may a location that is outside of a perimeter of the second location 510.

During the first stage A, the computing system 115 may display a first commercial reward when the computing system 115 determines that the electronic device 110 is located at the first location 505. For example, when the electronic device 110 is within the first location 505, the computing system 115 of the electronic device 110 may determine that the electronic device 110 is located within the first location 505 and display a first commercial reward using information from product profiles or producer profiles stored in the one or more servers 110 or received and stored in a memory of the electronic device 110. Additionally, or alternatively, the computing system 115 of the electronic device 110 may determine that the electronic device 110 is located within the first location 505 and display a first commercial reward using object information included with the image 400. The first commercial reward may include a first discount (e.g., a 10% discount) on one or more items including one or more objects within the transmitted image 400 that are associated with a specific producer, a specific brick-and-mortar store, or group of specific brick-and-mortar stores. The first commercial reward may be used for online purchases. In certain embodiments, the first commercial reward may be used for online purchases or purchases at any brick-and-mortar location that sells one or more items including the one or more objects within the image 400 that are associated with the specific producer.

The first commercial reward may also include an indication that if the electronic device 110 is transported to a second location 510, the computing system 115 of the electronic device 110 may display a second commercial reward when the electronic device 110 is within the second location 510. The second commercial reward may include a second discount that is different from the first discount (e.g., an increased discount, a 15% discount). The second commercial reward may also include additional features from the first commercial reward such as one or more complementary items included with a purchase of one or more items, a two-for-the-price-of-one reward, or the like. In certain embodiments, the second location 510 may be one or more brick-and-mortar stores selling one or more items including one or more objects within the transmitted image 400 that are associated with a specific producer, a specific brick-and-mortar store, or group of specific brick-and-mortar stores. In certain embodiments, the second location 510 may be an area that includes but is not limited to an identified brick-and-mortar store.

In certain embodiments, the second location 510 may be one or more different locations (e.g., one or more second locations 510). At least one of the one or more second locations 510 may be a location of a brick-and-mortar store. Thus, the first commercial reward may include an indication that if the electronic device 110 is transported to one or more identified brick-and-mortar stores selling one or more items including one or more objects within the transmitted image 400 that are associated with a specific producer, a specific brick-and-mortar store, or group of specific brick-and-mortar stores, the computing system 115 of the electronic device 110 may display a second commercial reward when the electronic device 110 is at anyone of the identified brick-and-mortar stores. In certain embodiments, the identified brick-and-mortar stores may include a brick-and-mortar store that is within a predetermined distance from the first location 505. For example, the computing system 115 may identify every brick-and-mortar store that is associated with the transmitted image 400 or one or more objects within the image 400 and determine which brick-and-mortar stores are within a predetermined distance from the first location 505 (e.g., within a predetermined distance from the electronic device 110). The computing system 115 may display (e.g., using a map, a list of one or more addresses) the determined brick-and-mortar stores that are within the predetermined distance from the first location 505.

Additionally, or alternatively, the identified brick-and-mortar stores may include a brick-and-mortar store that has sluggish sales. For example, the computing system 115 may identify every brick-and-mortar store that is associated with the transmitted image 400 or one or more objects within the image 400 and determine which brick-and-mortar stores have the least sales or the least revenue (e.g., relative to all of the associated brick-and-mortar stores). The computing system 115 may display (e.g., using a map, a list of one or more addresses) the determined brick-and-mortar stores that have the least sales or the least revenue.

Additionally, or alternatively, the identified brick-and-mortar stores may include a new brick-and-mortar store that is seeking to receive increased consumer awareness. For example, the computing system 115 may identify every brick-and-mortar store that is associated with the transmitted image 400 or one or more objects within the image 400 and determine which brick-and-mortar stores are the newest built brick-and-mortar stores or newest opened brick-and-mortar stores (e.g., relative to all of the associated brick-and-mortar stores). The computing system 115 may display (e.g., using a map, a list of one or more addresses) the determined brick-and-mortar stores that are the newest built brick-and-mortar stores or the newest opened brick-and-mortar stores.

In certain embodiments, the first commercial reward may include one or more addresses or one or more directions from the first location 505 to the second location 510. For example, the second location 510 may be a plurality of different second locations 510 that include one or more locations of identified brick-and-mortar stores. The first commercial reward may also include a list of each of the one or more identified brick-and-mortar stores and their respective locations. Upon receiving a selection of an identified brick-and-mortar store of the one or more identified brick-and-mortar stores from the list, the computing system 115 of the electronic device 110 may display directions from the first location to the location of the selected identified brick-and-mortar store (e.g., a second location 510 of one or more second locations 510). In certain embodiments, when the electronic device 110 is located at the first location 505, the displayed first commercial reward may be the only displayed commercial reward associated with one or more objects within the image 400 that are related to a specific producer. For example, when the electronic device 110 is located at the first location 505, the computing system 115 may not display both the first commercial reward and the second commercial reward described herein.

At the second stage B, the computing system 115 of the electronic device 110 may determine that the electronic device 110 is within a perimeter of the second location 510. In certain embodiments, as described herein, the second location 510 may be an identified brick-and-mortar store identified in the first commercial reward. When the electronic device 110 is within the second location 510, the computing system 115 of the electronic device 110 may determine that the electronic device 110 is located within the second location 510 and display a second commercial reward using product profiles or producers profiles stored in the one or more servers 110 or received and stored in a memory of the electronic device 110. The second commercial reward may include the second discount on one or more items including one or more objects within the transmitted image 400 that are associated with a specific producer using a product profile and producer profiles stored in the one or more servers 110 or received and stored in a memory of the electronic device 110. Additionally, or alternatively, the second commercial reward may include the second discount on one or more items including one or more objects within the transmitted image 400 that are associated with a specific producer, a specific brick-and-mortar store, or group of specific brick-and-mortar stores using object information included with the image 400. In certain embodiments, when the electronic device 110 is located within the second location 510, the computing system 115 may display both the first commercial reward and the second commercial reward.

At the third stage C, the computing system 115 of the electronic device 110 may determine that the electronic device 110 is no longer within the perimeter of the second location 510 and is now located at a third location 515. When the electronic device 110 is within the third location 515, the computing system 115 of the electronic device 110 may determine that the electronic device 110 is located within the third location 515 or determine that the electronic device 110 is no longer located at the second location 510 and display the first commercial reward using product profiles or producers profiles stored in the one or more servers 110 or received and stored in a memory of the electronic device 110. In certain embodiments, once the computing system 115 determines that the electronic device 110 has left the second location 510 and, for example, the computing system 115 determines that the electronic device 110 is located at the third location 515, the computing system 115 may no longer display both the first commercial reward and the second commercial reward alone or together. In certain embodiments, the third location 515 is a location that does not include the second location 510. Additionally, or alternatively, the third location 515 is any location outside the second location 510. Additionally, or alternatively, the third location 515 may include the first location 505.

In certain embodiments, the computing system 115 of the electronic device 110 may determine when the electronic device moves a distance towards a second location that is from a first location and display a commercial reward when the electronic device moves the distance towards the second location. For example, the computing system 115 of the electronic device 110 may identify at least one of a quantity of other electronic devices of the one or more other electronic devices that receive a selection of the transmitted image 400 or one or more objects within the transmitted image 400 or may identify a quantity of selections of one or more objects within the transmitted image 400 from one or more other electronic devices that received the transmitted image 400. The computing system 115 of the electronic device 110 may display a first commercial reward based on the first location 505 of the electronic device 110 and at least one of the quantity of selections from one or more other electronic devices or the quantity of other electronic devices that received a selection. Subsequently, the computing system 115 of the electronic device 110 may determine that the electronic device 110 has moved a predetermined distance away from the first location 505 or towards a second location 510 (e.g., a brick-and-mortar store) indicated in the first commercial reward. In response to determining that the electronic device 110 has moved a predetermined distance away from the first location 505 or a predetermined distance towards the second location 510, the computing system 115 may display at least one of a message (e.g., text, a map) identifying one or more specific associated brick-and-mortar stores that is in the direction that electronic device 110 is moving or the second commercial reward as described herein. Displaying at least one of the message or the second commercial reward while moving away from the first location or towards a second location may provide an alert or reminder to a viewer of the message or the displayed second commercial reward and encourage the viewer to go to a brick-and-mortar store to purchase an object within the transmitted image 400.

In certain embodiments, after the computing system 115 receives selections from the one or more other electronic devices, the computing system 115 may subsequently transmit the image (e.g., a second time, a third time, a tenth time) to the one or more other electronic devices for subsequent viewing. In certain embodiments, the computing system 115 of the electronic device 110, performing one or more interactive dynamic product display operations, may subsequently transmit the image based on a quantity of other electronic devices that receive a selection of the image or one or more objects within the image. For example, when a quantity of the one or more electronic devices receives a selection of the transmitted image or one or more objects within the transmitted image, the computing system 115 may receive the quantity of the one or more electronic devices and compare that quantity with a threshold quantity. If the computing system 115 determines that the quantity of the one or more electronic devices is greater than a threshold quantity, the computing system 115 may transmit the image for subsequent display (e.g., display again, a repeat display) by each of the one or more other electronic devices.

In certain embodiments, the computing system 115 of the electronic device 110, performing one or more interactive dynamic product display operations, may subsequently transmit the image based on a quantity of selections of the image or one or more objects within the image received from the one or more other electronic devices. For example, when a quantity of selections of the image or one or more objects within the image is received from the one or more other electronic devices, the computing system 115 may receive the quantity of selections and compare that quantity with a threshold quantity. If the computing system 115 determines that the quantity of selections is greater than a threshold quantity, the computing system 115 may transmit the image for subsequent display (e.g., display again, a repeat display) by each of the one or more other electronic devices.

In certain embodiments, the computing system 115 of the electronic device 110, performing one or more interactive dynamic product display operations, may subsequently transmit the image based on a quantity of other electronic devices that receive a selection of the image or one or more objects within the image and a time when the image was previously transmitted. For example, when a quantity of the one or more electronic devices receives a selection of the transmitted image or one or more objects within the transmitted image, the computing system 115 may receive the quantity of the one or more electronic devices and compare that quantity with a threshold quantity. The computing system 115 may also identify a time duration from the time that the image was previously transmitted to the time when the quantity exceeded the threshold quantity. If the computing system 115 determines that the quantity of the one or more electronic devices exceeds the threshold quantity before the time duration exceeded threshold time, the computing system 115 may transmit the image for subsequent display (e.g., display again, a repeat display) by each of the one or more other electronic devices.

In certain embodiments, the computing system 115 of the electronic device 110, performing one or more interactive dynamic product display operations, may subsequently transmit the image based on a quantity of selections of the image or one or more objects within the image received from the one or more other electronic devices and a time when the image was previously transmitted. For example, when a quantity of selections of the image or one or more objects within the image is received from the one or more other electronic devices, the computing system 115 may receive the quantity of selections and compare that quantity with a threshold quantity. The computing system 115 may also identify a time duration from the time that the image was previously transmitted to the time when the quantity exceeded the threshold quantity. If the computing system 115 determines that the quantity of the one or more selections exceeded the threshold quantity before the time duration exceeded a threshold time, the computing system 115 may transmit the image for subsequent display (e.g., display again, a repeat display) by each of the one or more other electronic devices.

As described herein, the computing system 115 of the electronic device 110 may transmit an image containing one or more objects to one or more other electronic devices using one or more social media platforms. In certain embodiments, at least one of the social media platforms may be a social media platform associated with the user interface login display 300 (“the social media platform”). Each of the electronic device 110 and the other one or more electronic devices may be storing in a memory for execution, by one or more processors, the social media platform to display a social media platform display. Each of the electronic device 110 and the other one or more electronic devices may be associated with their own user profile so that when an electronic device displays the social media platform display the social media platform displays a social media platform display that is unique to the user profile associated with the particular electronic device.

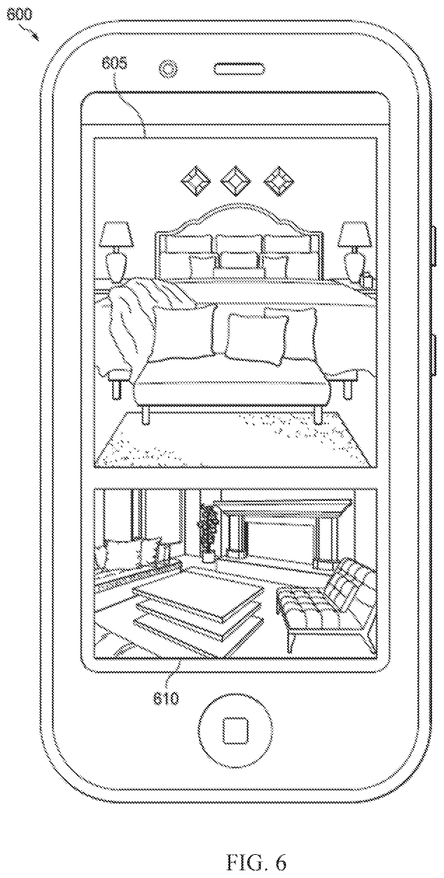

FIG. 6 illustrates an example social media platform display 600 according to certain embodiments of this disclosure. The social media platform display 600 may be displayed on at least one of the electronic device 110 or the one or more other electronic devices. As shown in FIG. 6, the social media platform display 600 may display a plurality of images (e.g., image 605, image 610) that may be scrolled through (e.g., up, down, left, right) or individually accessed for viewing by a viewer. Each of the images displayed in the social media platform display 600 may include the same or similar features described with respect to the image 400 of FIG. 4. For example, the images displayed in the social media platform display 600 may be selected or may contain one or more objects that may be selected as described herein.

In certain embodiments, when the computing system 115 transmits an image to one or more other electronic devices, as described herein, the transmitted image will populate at a new content position (e.g., the top) of the social media platform display 600 on each of the one or more other electronic devices. The new content position may be initially displayed when the computing system 115 generates the social media platform display 600 while older content positions require a received action (e.g., a scroll, a click) to view content in the older content positions. Subsequently, the social media platform display 600 displayed on each of the electronic devices may receive additional images that populate the new content position of the social media platform display 600 pushing the previously received images to the older content positions (e.g., down from the new content position) on the social media platform display 600 further away from the new content position and further out of the initial view. Images that receive a substantial quantity of selections may indicate a popularity of the image or one or more objects within the image.

As described herein, the one or more servers 120 may receive an indication that an image or one or more objects within the image has received a selection from the one or more other electronic devices. The one or more servers 120 may also store the image to associate the indication of the received selection with the image or one or more objects within the image. The one or more servers 120, performing one or more interactive dynamic product display operations, may determine a quantity of the selections received from the one or more other electronic devices for the image or one or more objects within the image. After (e.g., in response to) determining the quantity of the selections received from the one or more other electronic devices for the image or the one or more objects within the image, the one or more servers 120 may determine a rank for that image or one or more objects within that image.

In certain embodiments, the one or more servers 120, performing one or more interactive dynamic product display operations, may assign a rank to the image or one or more objects within the image based on a quantity of electronic devices that receive a selection of the image or one or more objects within the image and a threshold quantity. For example, when a quantity of electronic devices receive a selection of the image or one or more objects within the image, the one or more servers 120 may receive the quantity of electronic devices and compare that quantity with a threshold quantity. If the one or more servers 120 determine that the quantity of the electronic devices exceeds a threshold quantity, the one or more servers 120 may assign a rank to the image or one or more objects within the image based on the quantity exceeding the threshold quantity.

In certain embodiments, the one or more servers 120, performing one or more interactive dynamic product display operations, may assign a rank to the image or one or more objects within the image based on a quantity of selections of the image or one or more objects within the image received from the one or more other electronic devices and a threshold quantity. For example, when a quantity of selections of the image or one or more objects is received from one or more electronic devices, the one or more servers 120 may receive the quantity of selections and compare that quantity with a threshold quantity. If the one or more servers 120 determine that the quantity of the selections exceeds a threshold quantity, the one or more servers 120 may assign a rank to the image or one or more objects within the image based on the quantity exceeding the threshold quantity.

In certain embodiments, the one or more servers 120, performing one or more interactive dynamic product display operations, may assign a rank to the image or an object within the image based on a quantity of electronic devices that receive a selection of the image or one or more objects within the image relative to the quantities of electronic devices that receive selections of other images or one or more objects within the other images. For example, the one or more servers 120 may receive an indication of a quantity of electronic devices that receive a selection for an image or one or more objects within the image and determine that the quantity is a fifth largest quantity compared to all other images or objects within all other images that received selections from electronic devices. The one or more servers 120 may assign a rank of five to the image or the one or more objects within the image based on the comparison.

In certain embodiments, the one or more servers 120, performing one or more interactive dynamic product display operations, may assign a rank to the image or an object within the image based on the comparison between the quantity of received selections for the image or the one or more objects within the image and the quantities of selections received for other images or objects within the other images. For example, the one or more servers 120 may receive an indication of a quantity of selections for an image or one or more objects within the image from electronic devices and determine that the quantity is a tenth smallest quantity compared to all other images or objects within all other images that received selections from electronic devices. The one or more servers 120 may assign a rank that is an integer that is ten less the total number of images or objects within images that received a selection for the image or the one or more objects within the image based on the comparison.

In certain embodiments, the one or more servers 120, performing one or more interactive dynamic product display operations, may assign a rank to the image or an object within the image based on a quantity of electronic devices that receive a selection of the image or one or more objects within the image, a threshold quantity, a time when the image was previously transmitted, and a threshold time. For example, when a quantity of electronic devices receive a selection of the image or one or more objects, the one or more servers 120 may receive the quantity of selections and compare that quantity with a threshold quantity. The one or more servers 120 may also identify a time duration from the time that the image was previously transmitted to the time that the quantity exceeded the threshold quantity. If the one or more servers 120 determine that the quantity of the one or more selections exceeds the threshold quantity before the time duration exceeded the threshold time, the one or more servers 120 may assign a rank to the image or one or more objects within the image based on the quantity of the one or more selections exceeding the threshold quantity before the time duration exceeded the threshold time.

In certain embodiments, the one or more servers 120, performing one or more interactive dynamic product display operations, may assign a rank to the image or an object within the image based on a quantity of electronic devices that receive a selection of the image or one or more objects within the image, a threshold quantity, a time when the image was previously transmitted, and a threshold time. For example, when a quantity of electronic devices receive a selection of the image or one or more objects, the one or more servers 120 may receive the quantity of selections and compare that quantity with a threshold quantity. The one or more servers 120 may also identify a time duration from the time that the image was previously transmitted to the time that the quantity exceeded the threshold quantity. If the one or more servers 120 determine that the quantity of the one or more selections exceeds the threshold quantity before the time duration exceeded the threshold time, the one or more servers 120 may assign a rank to the image or one or more objects within the image based on the quantity of the one or more selections exceeding the threshold quantity before the time duration exceeded the threshold time.

In certain embodiments, the one or more servers 120, performing one or more interactive dynamic product display operations, may assign a rank to the image or an object within the image based on a quantity of electronic devices that receive a selection of the image or one or more objects within the image relative to the quantities of electronic devices that receive selections of other images or one or more objects within the other images, a time when the image was previously transmitted, and a time when each of the other images were previously transmitted. For example, the one or more servers 120 may receive an indication of a quantity of electronic devices that receive a selection for an image or one or more objects within the image. The one or more servers 120 may also determine a duration of time between a current time and a time when the image was previously transmitted and determine a selection rate of the image or one or more objects within the image. The one or more servers 120 may compare the selection rate of the image or one or more objects within the image and compare that selection rate with one or more other selections rates of one or more other images or one or more objects within one or more other images. The one or more servers 120 may assign a rank to the image or one or more objects within the image based on the quantity of the one or more selections exceeding the threshold quantity before the time duration exceeded the threshold time.

In certain embodiments, the one or more servers 120, performing one or more interactive dynamic product display operations, may assign a rank to the image or an object within the image based on a quantity of selections received of the image or one or more objects within the image from electronic devices relative to the quantities of selections received of other images or one or more objects within the other images from electronic devices, a time when the image was previously transmitted, and a time when each of the other images were previously transmitted. For example, the one or more servers 120 may receive an indication of a first quantity of selection received for an image or one or more objects within the image. The one or more servers 120 may also determine a duration of time between a current time and a time when the image was previously transmitted and determine a selection rate of the image or one or more objects within the image. The one or more servers 120 may compare the selection rate of the image or one or more objects within the image and compare that selection rate with one or more other selections rates of one or more other images or one or more objects within one or more other images. The one or more servers 120 may transmit the image to each of the electronic devices executing or capable of executing the social media platform to display the image in the social media platform display 600 according to the rank.

In certain embodiments, the one or more serves 120 may transmit the image to each of the electronic devices based on the rank. For example, the one or more servers 120 may transmit the image when the image has a higher rank (e.g., a lower numerical value) before transmitting other images that have a lower rank (e.g., a higher numerical value). In certain embodiments, the one or more servers 120 may transmit the image based on the rank and a time since the image was initially transmitted by the computing system 115 of the electronic device 110. For example, when the time between a current and a time when the computing system 115 of the electronic device 110 transmits the image to the one or more other electronic devices exceeds a threshold time, the one or more servers 120 may determine to abstain from transmitting the image to electronic devices. When the time between a current and a time when the computing system 115 of the electronic device 110 transmits the image to the one or more other electronic devices does not exceed a threshold time, the one or more servers 120 may transmit the image to electronic devices.

As described herein, the computing system 115 of the electronic device 110 may receive an indication that an image or one or more objects within the image has received a selection from the one or more other electronic devices. The computing system 115 of the electronic device 110, performing one or more interactive dynamic product display operations, may determine a quantity of the selections received from the one or more other electronic devices for the image or one or more objects within the image. After (e.g., in response to) determining the quantity of the selections received from the one or more other electronic devices for the image or the one or more objects within the image, the computing system 115 of the electronic device 110 may determine a rank for that image or one or more objects within that image.

In certain embodiments, the computing system 115 of the electronic device 110, performing one or more interactive dynamic product display operations, may assign a rank to the image or one or more objects within the image based on a quantity of electronic devices that receive a selection of the image or one or more objects within the image and a threshold quantity. For example, when a quantity of electronic devices receive a selection of the image or one or more objects within the image, the computing system 115 of the electronic device 110 may receive the quantity of electronic devices and compare that quantity with a threshold quantity. If the computing system 115 of the electronic device 110 determine that the quantity of the electronic devices exceeds a threshold quantity, the one or more servers 120 may assign a rank to the image or one or more objects within the image based on the quantity exceeding the threshold quantity.

In certain embodiments, the computing system 115 of the electronic device 110, performing one or more interactive dynamic product display operations, may assign a rank to the image or one or more objects within the image based on a quantity of selections of the image or one or more objects within the image received from the one or more other electronic devices and a threshold quantity. For example, when a quantity of selections of the image or one or more objects is received from one or more electronic devices, the computing system 115 of the electronic device 110 may receive the quantity of selections and compare that quantity with a threshold quantity. If the computing system 115 of the electronic device 110 determine that the quantity of the selections exceeds a threshold quantity, the computing system 115 of the electronic device 110 may assign a rank to the image or one or more objects within the image based on the quantity exceeding the threshold quantity.

In certain embodiments, the computing system 115 of the electronic device 110, performing one or more interactive dynamic product display operations, may assign a rank to the image or an object within the image based on a quantity of electronic devices that receive a selection of the image or one or more objects within the image relative to the quantities of electronic devices that receive selections of other images or one or more objects within the other images. For example, the computing system 115 of the electronic device 110 may receive an indication of a quantity of electronic devices that receive a selection for an image or one or more objects within the image and determine that the quantity is a fifth largest quantity compared to all other images or objects within all other images that received selections from electronic devices. The computing system 115 of the electronic device 110 may assign a rank of five to the image or the one or more objects within the image based on the comparison.

In certain embodiments, the computing system 115 of the electronic device 110, performing one or more interactive dynamic product display operations, may assign a rank to the image or an object within the image based on the comparison between the quantity of received selections for the image or the one or more objects within the image and the quantities of selections received for other images or objects within the other images. For example, the computing system 115 of the electronic device 110 may receive an indication of a quantity of selections for an image or one or more objects within the image from electronic devices and determine that the quantity is a tenth smallest quantity compared to all other images or objects within all other images that received selections from electronic devices. The computing system 115 of the electronic device 110 may assign a rank that is an integer that is ten less the total number of images or objects within images that received a selection for the image or the one or more objects within the image based on the comparison.

In certain embodiments, the computing system 115 of the electronic device 110, performing one or more interactive dynamic product display operations, may assign a rank to the image or an object within the image based on a quantity of electronic devices that receive a selection of the image or one or more objects within the image, a threshold quantity, a time when the image was previously transmitted, and a threshold time. For example, when a quantity of electronic devices receive a selection of the image or one or more objects, the computing system 115 of the electronic device 110 may receive the quantity of selections and compare that quantity with a threshold quantity. The computing system 115 of the electronic device 110 may also identify a time duration from the time that the image was previously transmitted to the time that the quantity exceeded the threshold quantity. If the computing system 115 of the electronic device 110 determines that the quantity of the one or more selections exceeds the threshold quantity before the time duration exceeded the threshold time, the computing system 115 of the electronic device 110 may assign a rank to the image or one or more objects within the image based on the quantity of the one or more selections exceeding the threshold quantity before the time duration exceeded the threshold time.

In certain embodiments, the computing system 115 of the electronic device 110, performing one or more interactive dynamic product display operations, may assign a rank to the image or an object within the image based on a quantity of electronic devices that receive a selection of the image or one or more objects within the image, a threshold quantity, a time when the image was previously transmitted, and a threshold time. For example, when a quantity of electronic devices receive a selection of the image or one or more objects, the computing system 115 of the electronic device 110 may receive the quantity of selections and compare that quantity with a threshold quantity. The computing system 115 of the electronic device 110 may also identify a time duration from the time that the image was previously transmitted to the time that the quantity exceeded the threshold quantity. If the computing system 115 of the electronic device 110 determine that the quantity of the one or more selections exceeds the threshold quantity before the time duration exceeded the threshold time, the computing system 115 of the electronic device 110 may assign a rank to the image or one or more objects within the image based on the quantity of the one or more selections exceeding the threshold quantity before the time duration exceeded the threshold time.

In certain embodiments, the computing system 115 of the electronic device 110, performing one or more interactive dynamic product display operations, may assign a rank to the image or an object within the image based on a quantity of electronic devices that receive a selection of the image or one or more objects within the image relative to the quantities of electronic devices that receive selections of other images or one or more objects within the other images, a time when the image was previously transmitted, and a time when each of the other images were previously transmitted. For example, the computing system 115 of the electronic device 110 may receive an indication of a quantity of electronic devices that receive a selection for an image or one or more objects within the image. The computing system 115 of the electronic device 110 may also determine a duration of time between a current time and a time when the image was previously transmitted and determine a selection rate of the image or one or more objects within the image. The computing system 115 of the electronic device 110 may compare the selection rate of the image or one or more objects within the image and compare that selection rate with one or more other selections rates of one or more other images or one or more objects within one or more other images. The computing system 115 of the electronic device 110 may assign a rank to the image or one or more objects within the image based on the quantity of the one or more selections exceeding the threshold quantity before the time duration exceeded the threshold time.

In certain embodiments, the computing system 115 of the electronic device 110, performing one or more interactive dynamic product display operations, may assign a rank to the image or an object within the image based on a quantity of selections received of the image or one or more objects within the image from electronic devices relative to the quantities of selections received of other images or one or more objects within the other images from electronic devices, a time when the image was previously transmitted, and a time when each of the other images were previously transmitted. For example, the computing system 115 of the electronic device 110 may receive an indication of a first quantity of selection received for an image or one or more objects within the image. The computing system 115 of the electronic device 110 may also determine a duration of time between a current time and a time when the image was previously transmitted and determine a selection rate of the image or one or more objects within the image. The computing system 115 of the electronic device 110 may compare the selection rate of the image or one or more objects within the image and compare that selection rate with one or more other selections rates of one or more other images or one or more objects within one or more other images. The computing system 115 of the electronic device 110 may transmit the image to each of the electronic devices executing or capable of executing the social media platform to display the image in the social media platform display 600 according to the rank.

In certain embodiments, the computing system 115 of the electronic device 110 may transmit the image to each of the electronic devices based on the rank. For example, the computing system 115 of the electronic device 110 may transmit the image when the image has a higher rank (e.g., a lower numerical value) before transmitting other images that have a lower rank (e.g., a higher numerical value). In certain embodiments, the computing system 115 of the electronic device 110 may transmit the image based on the rank and a time since the image was initially transmitted by the computing system 115 of the electronic device 110. For example, when the time between a current and a time when the computing system 115 of the electronic device 110 transmits the image to the one or more other electronic devices exceeds a threshold time, the computing system 115 of the electronic device 110 may determine to abstain from transmitting the image to electronic devices. When the time between a current and a time when the computing system 115 of the electronic device 110 transmits the image to the one or more other electronic devices does not exceed a threshold time, the computing system 115 of the electronic device 110 may transmit the image to electronic devices.

As described herein, when the computing system 115 initially transmits an image to one or more other electronic devices, the transmitted image will populate at a new content position (e.g., the top) of the social media platform display 600 on each of the one or more other electronic devices. The new content position may be initially displayed when the computing system 115 generates the social media platform display 600 while older content positions require a received action (e.g., a scroll, a click) to view content in the older content positions. Subsequently, the social media platform display 600 displayed on each of the electronic devices may receive additional images that populate the new content position of the social media platform display 600 pushing the previously received images to the older content positions (e.g., down from the new content position) on the social media platform display 600 further away from the new content position and further out of the initial view. Images that receive a substantial quantity of selections may indicate a popularity of the image or one or more objects within the image.

Each of the one or more other electronic devices may subsequently receive one or more previously transmitted images based on the rank of the image. For example, at least one of the computing system 115 of the electronic device 110 or the one or more servers 120 may transmit one or more previously transmitted images to each of the one or more other electronic devices one or more subsequent times in the new content position based on a rank assigned to the image. As another example, when each of the one or more other electronic devices receive images and their respective ranks, each of the one or more other electronic devices may display the received images in the new content position based a rank of each received image compared to the other received images (e.g., in a sequence, in an order).

FIG. 7 illustrates a method 700 implemented by the computing system 115 of an electronic device 110 performing one or more interactive dynamic product display operations according to certain embodiments of this disclosure. Although certain details will be provided with reference to the method 700 of FIG. 7, it should be understood that other embodiments may include more, less, or different method steps. At step 701, the computing system 115 of the electronic device 110 is in an idle state at least with respect to performing one or more interactive dynamic product display operations.

At step 703, the computing system 115 of the electronic device 110 receives a selection of an image of one or more objects. For example, the computing system 115 may generate for display an image of one or more object and display the image on a display screen of the electronic device 110. The image may have been created by a user logged into their user account for posting the image on one or more social media websites or social media platforms (hereinafter “social media platforms”) (e.g., FACEBOOK™, PINTREST™, WHATSIT™, INSTAGRAM™, the social media platform) or the image may have been copied from one or more webpages and placed into the user account for posting the image on the one or more social media platforms. The image may contain one or more objects arranged in a decorative fashion for a viewer to see how each object may be arranged for display amongst other objects. In certain embodiments, the one or more objects may include at least one of a furniture piece, a decorative item, a furniture piece accessory, an article of clothing, a clothing accessory, or the like.

At least one object of the one or more objects may include a product that is sold by one or more producers. For example, the decorative pillow set 410 illustrated in FIG. 4 may be sold directly by a manufacturer both online and through one or more manufacturer direct brick-and-mortar locations. The comforter 415 illustrated in FIG. 4 may be sold at one or more retail stores both online and through brick-and-mortar locations. The ottoman 420 illustrated in FIG. 4 may be sold at only one or more brick-and-mortar retail store locations.

The image may have a marker that is associated with every object or at least one object within the image or with the image itself. For example, when the image is placed into the user account for posting the image to the one or more social media platforms, the image may be marked with a marker. The marker may be inserted into or with the image (e.g., on a region of the image, on the entire image, or through a selection button associated with the image). In certain embodiments, the marker may include a symbol (e.g., a pictorial symbol, an alpha-numeric character sequence) displayed on the image. Additionally, or alternatively, the marker may include an invisible or shaded region on the image. The marker for the image may be selectable. For example, after the image is marked with a marker, the marker may be selected through at least one of a touch-input on the location of the marker, through a movement and click of a cursor on the location of the marker, through a selection window listing the marker and the associated image, or the like. The computing system 115 of the electronic device 110 may receive a selection of a marker through a display screen or through a user input interface and interpret the selection of the marker as a selection of the image associated with the marker. A received selection of an image may be indicative of an interest that a user viewing the image has in every object within the image, at least one object within the image, the arrangement of the objects within the image, the image itself, or the like.

Additionally, or alternatively, each of the one or more objects within the image may include a marker. For example, when the image is placed into the user account for posting the image to the one or more social media platforms, each of the one or more objects may be marked with a marker. The marker may be inserted into the image at the location of the object. In certain embodiments, the marker may include a symbol (e.g., a pictorial symbol, an alpha-numeric character sequence) displayed on the object in the image. Additionally, or alternatively, the marker may include an invisible or shaded region within the location of the object in the image. Each of the one or more markers may be selectable. For example, after one or more objects within the image are marked with a marker, at least one marker of the one or more markers may be selected through at least one of a touch-input on the location of the marker in the image on the display screen, through a movement and click of a cursor on the location of the marker in the image on the display screen, through a selection window listing the one or more markers displayed on each of the one or more objects in the image on the display screen, or the like. The computing system 115 of the electronic device 110 may receive a selection of a marker through a display screen or through a user input interface and interpret the selection of the marker as a selection of the object associated with the marker. A received selection of an object may be indicative of an interest that a user viewing the image has in the selected object.

The image may include image information. For example, when the image is marked with a marker, image information associated with the image may be provided to the computing system 115 through a user interface (e.g., a user interface image information input screen). The image information for the image may be stored in an embedded electronic file with the image or may be included in the image itself (e.g., for viewing on the image) so that when the image is transmitted to another electronic device, the image information for the image may be accessed and viewed through a display window on a display screen or on the image itself. Additionally, or alternatively, the image information for the image may be stored in an embedded electronic file with the image so that when the image 400 is transmitted to the one or more servers 120, the image information for the image may be stored in an image profile associated with the image, a user profile associated with a user, or a producer file associated with a producers of the image or at least one object within the image. Image information may include at least one of at least one of a source of the image, one or more brands associated with the image, one or more retail stores associated with the image, or the like.

Additionally, or alternatively, each of the one or more objects within the image may include object information. For example, when each of the one or more objects is marked with a marker, object information associated with each marked object may be provided to the computing system 115 through a user interface (e.g., a user interface object information input screen). The object information for each marked object may be stored in an embedded electronic file with the image or may be included in the image itself (e.g., for viewing on the image) so that when the image is transmitted to another electronic device, the object information for each object may be accessed and viewed through a display window on a display screen or on the image itself. Additionally, or alternatively, the object information for each marked object may be stored in an embedded electronic file with the image so that when the image is transmitted to the one or more servers 120, the object information for each object may be stored in an image profile associated with the image, a user profile associated with a user, or a producer file associated with a producers of the image or at least one object within the image. Object information may include at least one of an object name, an object type, an object characteristic, an object price, an object color, one or more object dimensions, an object material, an object brand, an object manufacturer, one or more retail stores that sell the object, a location of one or more retail stores that sell the object, one or more retail stores that sell related objects, a location of one or more retail stores that sell related objects, or the like.

At step 705, the computing system 115 of the electronic device 110 transmits the image to one or more other electronic devices for display after receiving the selection of the image. In certain embodiments, the computing system 115 of the electronic device 110 transmits the image to one or more other electronic devices for display in response to receiving the selection of the image. For example, after the image is displayed on a display screen and the computing system 115 of the electronic device 110 receives a selection of at least one of the image or one or more objects within the image, the computing system 115 may transmit the image to one or more other electronic devices. In certain embodiments, the computing system 115 may transmit the image to one or more other electronic devices through SMS messaging communication, email communication, direct near field communication (NFC), or the like. For example, a memory of the electronic device 110 may store one or more contacts containing at least one of a mobile phone number or an email address associated with each of the one or more contacts. After the image is displayed on a display screen and the computing system 115 of the electronic device 110 receives a selection of at least one of the image or one or more objects within the image, the computing system 115 may transmit the image to one or more other electronic devices via SMS communication using the mobile phone numbers stored in the one or more contacts, via email communication using the email addresses stored in the one or more contacts, or via NFC using detected transmitters of the one or more other electronic devices.

In certain embodiments, the computing system 115 may transmit the image to one or more other electronic devices 110 through one or more social media platforms. For example, a user of a user profile may have a user account with one or more social media platforms. On each social media platform, the user account may share information (e.g., pictures, videos, text) with one or more user account approved contacts. The user accounts for each of the one or more social media platforms may also be linked or associated with the user profile associated with the interactive dynamic product display operations. After the image is displayed on a display screen and the computing system 115 of the electronic device 110 receives a selection of at least one of the image or one or more objects within the image, the computing system 115, performing one or more interactive dynamic product display operations, may generate for display a social media platform selection menu. The social media platform selection menu may include one or more selections to transmit the image to other electronic devices 110 through one or more social media platforms. After selecting one or more social media platforms, the computing system 115 may access the user account associated with the user profile for each of the selected one or more social media platforms and transmit the image through the user accounts of each of the social media platforms to other electronic devices that are used by the contacts associated with the user accounts of each of the social media platforms.

In certain embodiments, when the computing system 115 transmits the image to the one or more other electronic devices, the image may include an indication that the computing system 115 has received a selection of at least one of the image or one or more objects within the image. For example, when the computing system 115 transmits the image to one or more other electronic devices through an electronic communication (e.g., SMS messaging communication, email communication, NFC, one or more social media platforms), the transmitted image may contain an indication that at least one of the transmitted image or one or more objects within the transmitted image received a selection. When each of the one or more other electronic devices receives the transmitted image and displays the transmitted image on a display screen, the indication that the computing system 115 has received a selection of at least one of the image or one or more objects within the image may be displayed when the transmitted image is displayed by each of the one or more other electronic devices. The indication that the computing system 115 has received a selection of at least one of the image or one or more objects within the image may inform the viewer viewing a display screen of at least one of the one or more other electronic devices that a viewer (e.g., a view associated with a user profile) associated with the computing system 115 may have a particular interest in the selected image or one or more selected objects within the image.

At step 707, the computing system 115 of the electronic device 110 identifies a quantity of at least one other electronic device of the one or more other electronic devices that receives a selection of the image after the image is transmitted to the one or more other electronic devices for display. For example, when the computing system 115 transmits the image 400 to the one or more other electronic devices, the computing system 115 may include an electronic tag with the image 400. The electronic tag may link the image 400 to the computing system 115 (e.g., the computing system 115 that transmitted the image 400, a user profile that transmitted the image 400 through the computing system 115). In certain embodiments, described herein, the electronic tag may include instructions for a processor of another electronic device that receives the transmitted image 400 from the computing system 115 of the electronic device 110 to generate a coupon or voucher on a display screen of the other electronic device when the other electronic device receives a selection of the transmitted image 400 or a selection of one or more objects within the transmitted image 400.

In certain embodiments, the electronic tag may provide instructions to each of the other electronic devices to detect when the other electronic devices receive a selection of the image 400 or a selection of one or more objects within the image 400. When a processor of another electronic device displaying the transmitted image 400 detects the reception of a selection of the image 400 or one or more objects within the image 400, the processor of the other electronic device, through the instructions from the electronic tag, may transmit a selection indication to at least one of the one or more servers 120 or the electronic device 110. The selection indication may include an indication that the image 400 or one or more objects within the image 400 were selected, and when one or more objects within the image 400 are selected, identify which one or more objects within the image 400 were selected. The selection indication may also include an identification of the computing system 115 that transmitted the image 400 (e.g., a user profile that transmitted the image 400 through the computing system 115) to the other electronic device. When the computing system 115 of the electronic device 110 receives the selection indication, the computing system 115 may store the selection indication in a data store with one or more other selection indications associated with the image 400 or associated with an object within the image 400. The computing system 115 may identify a quantity of other electronic devices that receive a selection of the image or a quantity of other electronic devices that receive a selection of a particular object within the image 400 using the stored selection indications.

In certain embodiments, when the one or more servers 120 receive the selection indication, the one or more servers 120 may store the selection indication with one or more other selection indications associated with the image 400. The one or more servers 120 may identify a quantity of other electronic devices that receive a selection of the image 400 or a quantity of other electronic devices that receive a selection of a particular object within the image 400 using the stored selection indications. The one or more servers 120 may transmit the quantity of other electronic devices that receive a selection of the image or the quantity of other electronic devices that receive a selection of a particular object within the image 400 to the computing system 115 of the electronic device 110.

At step 709, the computing system 115 of the electronic device 110 determines a location of the electronic device 110. In certain embodiments, the computing system 115 may utilize a global positioning system (GPS), triangulation between two or more base stations, an accelerometer, NFC, a combination thereof, or the like to determine a location of the electronic device. The computing system 115 may determine GPS coordinates of the electronic device 110, an address of the electronic device 110, a location of the electronic device 110 relative to another location, or the like. For example, the computing system 115 may determine that the electronic device 110 is located at a residence associated with a user profile that is being accessed through the electronic device 110. As another example, the computing system 115 may determine that the electronic device 110 is located within a brick-and-mortar store selling one or more items displayed as objects in an image transmitted by the computing system 115 (e.g., the user profile associated with the computing system 115). As yet another example, the computing system 115 may determine that the electronic device 110 is located immediately outside or within a distance of a brick-and-mortar store selling one or more items displayed as objects in an image transmitted by the computing system 115. As another example, the computing system 115 may determine that the electronic device 110 is being transported in a direction towards a brick-and-mortar store selling one or more items displayed as objects in an image transmitted by the computing system 115. As yet another example, the computing system 115 may determine the location of the electronic device 110 to provide a distance between the location of the electronic device 110 and one or more brick-and-mortar stores selling one or more items displayed as objects in an image transmitted by the computing system 115. As another example, the computing system 115 may determine the location of the electronic device 110 to provide directions from the location of the electronic device 110 to one or more brick-and-mortar stores selling one or more items displayed as objects in an image transmitted by the computing system 115. As described herein, the computing system 115 may determine a location of the electronic device 110 to display one or more commercial rewards on a display screen of the electronic device 110.

At step 711, the computing system 115 of the electronic device 110 displays one or more commercial rewards. Commercial rewards may be rewards electronically provided to an electronic device 110 (e.g., an electronic device associated with a user profile) that provide an incentive to a user associated with the electronic device (e.g., a user profile associated with the electronic device 110) to purchase an item. A commercial reward may include at least one of a discount sales price for one or more objects within a transmitted image, a discount sales price for an object within a transmitted image 400 that was selected by a largest quantity of electronic devices of the one or more other electronic devices, a discount sales price for an object within a transmitted image 400 that was selected by a quantity of electronic devices of the one or more other electronic devices that is above a threshold quantity, a discount sales price for at least one object of the one or more objects within the transmitted image that received a selection, a discount sales price for one or more items for sale by one or more sources (e.g., a brick-and-mortar store, an electronic store) that sell at least one object of the one or more objects within the transmitted image, a voucher for a promotional item from one or more manufacturers or retail stores that are associated with the transmitted image or at least one object of the one or more objects within the transmitted image, a voucher to receive a monetary sum from a manufacturer or a retail store that is associated with an object of the one or more objects within the transmitted image, a voucher to receive an object of the one or more objects within the transmitted image from a manufacturer or a retail store that is associated with the transmitted image, or the like.

In certain embodiments, the computing system 115 of the electronic device 100 displays one or more commercial rewards based on a quantity of other electronic devices that receive a selection of a transmitted image or a quantity of other electronic devices that receive a selection of a particular object within a transmitted image. For example, the computing system 115 may receive a selection of the image 400 displayed on a display screen (e.g., a display screen of the electronic device 110, a display screen in electronic communication with the computing system 115). The computing system 115 may transmit the image 400 including the indication that the computing system 115 of the electronic device 110 (e.g., a user profile associated with the electronic device 110) received a selection of the image 400 to one or more other electronic devices through a social media platform. Each of the one or more other electronic devices may be associated with a user account that is in contact with or able to view content from the user account of the electronic device 115. At least one of the one or more other electronic devices may receive a selection of the image 400 or a selection of particular one or more objects within the image 400 and transmit the selection to at least one of the one or more servers 120 or the computing system 115 of the electronic device 110. The computing system 115 may receive each of the selections from the at least one other electronic device of the one or more other electronic devices and determine or identify a quantity of other electronic devices of the one or more other electronic devices that received a selection of the image 400 or a selection of one or more particular objects within the image 400.

The computing system 115 may display (e.g., generate for display on a display screen) one or more commercial rewards based on a quantity of other electronic device that received a selection of the image 400 or one or more objects within the image 400. For example, the computing system 115 may generate, for display on a display screen of the electronic device 110, a commercial reward of a 5% discount for one or more products from a producer associated with the image 400 or one or more object within the image 400 when the quantity of other electronic devices that receive a selection of the image 400 transmitted from the electronic device (e.g., a user profile associated with the electronic device 110) is above a first threshold. As another example, the computing system 115 may generate, for display on a display screen of the electronic device 110, a commercial reward of a 10% discount for one or more products from a producer associated with the image 400 or one or more object within the image 400 when the quantity of other electronic devices that receive a selection of the image 400 transmitted from the electronic device (e.g., a user profile associated with the electronic device 110) is above a second threshold that is greater than the first threshold. As yet another example, the computing system 115 may generate, for display on a display screen of the electronic device 110, a commercial reward of a complimentary product and a 10% discount for one or more products from a producer associated with the image 400 or one or more object within the image 400 when the quantity of other electronic devices that receive a selection of the image 400 transmitted from the electronic device (e.g., a user profile associated with the electronic device 110) is above a third threshold that is greater than the second threshold.

Additionally, or alternatively, the computing system 115 may display (e.g., generate for display on a display screen) one or more commercial rewards based on a quantity of selections received of one or more objects within the image 400 from one or more other electronic devices that received the transmitted image 400. For example, the computing system 115 may generate, for display on a display screen of the electronic device 110, a commercial reward of a 5% discount for one or more products from a producer associated with at least one particular object within the image 400 when the quantity of selections received for one or more particular objects within the image 400 from one or more other electronic devices is above a first threshold. Another example, the computing system 115 may generate, for display on a display screen of the electronic device 110, a commercial reward of a 10% discount for one or more products from a producer associated with at least one particular object within the image 400 when the quantity of selections received for one or more particular objects within the image 400 from one or more other electronic devices is above a second threshold that is greater than the first threshold. As yet another example, the computing system 115 may generate, for display on a display screen of the electronic device 110, a commercial reward of a complimentary product and a 10% discount for one or more products from a producer associated with at least one particular object within the image 400 when the quantity of selections received for one or more particular objects within the image 400 from one or more other electronic devices is above a third threshold that is greater than the second threshold.

As described herein, the electronic tag included with the transmitted image 400 from the computing system 115 of the electronic device 110 may include instructions for a processor of another electronic device that receives the transmitted image 400 to generate a coupon or voucher on a display screen of the other electronic device when the other electronic device receives a selection of the transmitted image or a selection of one or more objects within the transmitted image 400. The coupon or voucher may provide a discount to the other electronic device (e.g., a user profile associated with the other electronic device) for purchasing an object in the image 400 selected by the other electronic device or a discount for purchasing an object selected by the other electronic device through the image 400.

In certain embodiments, the coupon or voucher may include a code (e.g., a bar code, an image, an alpha-numeric code) that may be provided to a producer to receive a discount when purchasing an object within the image 400. In some embodiments, the code may be a code that is unique to the computing system 115 of the electronic device 110 (e.g., a user profile associated with the computing system 115 of the electronic device 110) that transmitted the image 400 to the other electronic device and that is unique to the image 400 or one or more objects within the image 400. When the producer receives the code during a sale of an object within the image 400, the producer may attribute the sale of the object (and additionally, or alternatively, the sale of one or more additional items purchased with the sale of the object) to the computing system 115 of the electronic device 110 (e.g., the user profile associated with the computing system 115 of the electronic device 110) that transmitted the image 400 to the other electronic device based on the unique code. The producer may transmit a sale indication to the one or more servers 120 or the computing system 115 of the electronic device 110 including a sale price for the purchased object and a total sale price for an entire purchase that includes the sale price for the purchased object. The sale indication may also attribute the sale price for the purchased object and a total sale price for an entire purchase that includes the sale price for the purchased object to the computing system 115 of electronic device 110 (e.g., the user profile associated with the computing system 115 of the electronic device 110). The one or more servers 120 or the computing system 115 of the electronic device 110 may store an accumulating sales amount from each of one or more producers associated with one or more objects in one or more images and attribute the accumulating sales amount to the computing system 115 of the electronic device 110. When the attributed accumulating sales amount from a producer of one or more objects in an image reaches a threshold, the computing system 115 of the electronic device 110 may display a commercial reward that includes a voucher for a discount as described herein or monetary compensation (e.g., a commission).

In certain embodiments, the coupon or voucher may include a field to populate with a code (e.g., an alpha-numeric code) that is provided by a producer when the coupon or voucher is provided to the producer to receive a discount when purchasing an object within the image 400. The code may be a code that is unique to the object from the image 400 being purchased or to the transmitted image 400 containing the object being purchased. The code may also be indicative of the sales price for the purchased object or the total sales price for a group of items purchased with the purchased object from the image 400. When the field receives the code during or after a sale that includes an object within the image 400, the other electronic device may transmit a sales indication based on the code to at least one of the one or more server 120 or the computing system 115 of the electronic device 110. The sale indications may include a sale price for the purchased object and a total sale price for an entire purchase that includes the sale price for the purchased object. The sale indication may also attribute the sale price for the purchased object and a total sale price for an entire purchase that includes the sale price for the purchased object to the computing system 115 of electronic device 110 (e.g., the user profile associated with the computing system 115 of the electronic device 110). The one or more servers 120 or the computing system 115 of the electronic device 110 may store an accumulating sales amount from each of one or more producers associated with one or more objects in one or more images and attribute the accumulating sales amount to the computing system 115 of the electronic device 110. When the attributed accumulating sales amount from a producer of one or more objects in an image reaches a threshold, the computing system 115 of the electronic device 110 may display a commercial reward that includes a voucher for a discount as described herein or monetary compensation (e.g., a commission).

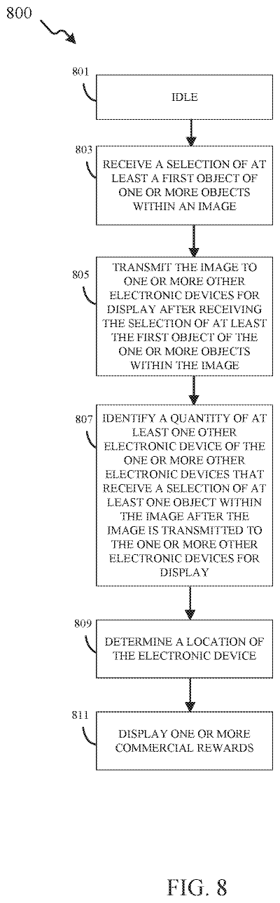

FIG. 8 illustrates a method 800 implemented by the computing system 115 of an electronic device 110 performing one or more interactive dynamic product display operations according to certain embodiments of this disclosure. Although certain details will be provided with reference to the method 800 of FIG. 8, it should be understood that other embodiments may include more, less, or different method steps. At step 801, the computing system 115 of the electronic device 110 is in an idle state at least with respect to performing one or more interactive dynamic product display operations. Step 801 is at least similar to step 701 illustrated in FIG. 7. At step 803, the computing system 115 of the electronic device 110 receives a selection of at least a first object of one or more objects within an image. Step 803 is at least similar to step 703 illustrated in FIG. 7. At step 805, the computing system 115 of the electronic device 110 transmits the image to one or more other electronic devices for display after receiving the selection of at least the first object of the one or more objects within the image. Step 805 is at least similar to step 705 illustrated in FIG. 7. At step 807, the computing system 115 of the electronic device 110 identifies a quantity of at least one other electronic device of the one or more other electronic devices that receive a selection of at least one object within the image after the image is transmitted to the one or more other electronic devices for display. Step 807 is at least similar to step 707 illustrated in FIG. 7. At step 809, the computing system 115 of the electronic device 110 determines a location of the electronic device. Step 809 is at least similar to step 709 illustrated in FIG. 7. At step 811, the computing system 115 of the electronic device 110 displays one or more commercial rewards. Step 811 is at least similar to step 711 illustrated in FIG. 7.

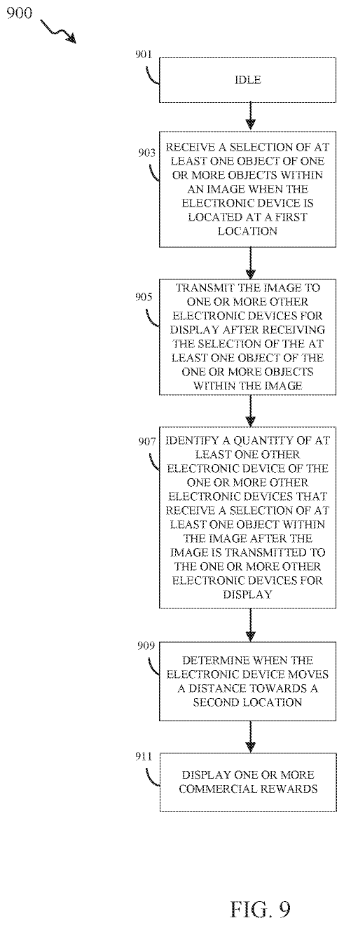

FIG. 9 illustrates a method 900 implemented by the computing system 115 of an electronic device 110 performing one or more interactive dynamic product display operations according to certain embodiments of this disclosure. Although certain details will be provided with reference to the method 900 of FIG. 9, it should be understood that other embodiments may include more, less, or different method steps. At step 901, the computing system 115 of the electronic device 110 is in an idle state at least with respect to performing one or more interactive dynamic product display operations. Step 901 is at least similar to step 701 illustrated in FIG. 7. At step 903, the computing system 115 of the electronic device 110 receives a selection of at least one object of one or more objects within an image when the electronic device is located at a first location. Step 903 is at least similar to step 703 illustrated in FIG. 7. At step 905, the computing system 115 of the electronic device 110 transmits the image to one or more other electronic devices for display after receiving the selection of at least the first object of the one or more objects within the image. Step 905 is at least similar to step 705 illustrated in FIG. 7. At step 907, the computing system 115 of the electronic device 110 identifies a quantity of at least one other electronic device of the one or more other electronic devices that receive a selection of at least one object within the image after the image is transmitted to the one or more other electronic devices for display. Step 907 is at least similar to step 707 illustrated in FIG. 7. At step 809, the computing system 115 of the electronic device 110 determines when the electronic device 110 moves a distance towards a second location. Step 909 is at least similar to step 709 illustrated in FIG. 7. At step 911, the computing system 115 of the electronic device 110 displays one or more commercial rewards. Step 911 is at least similar to step 711 illustrated in FIG. 7.

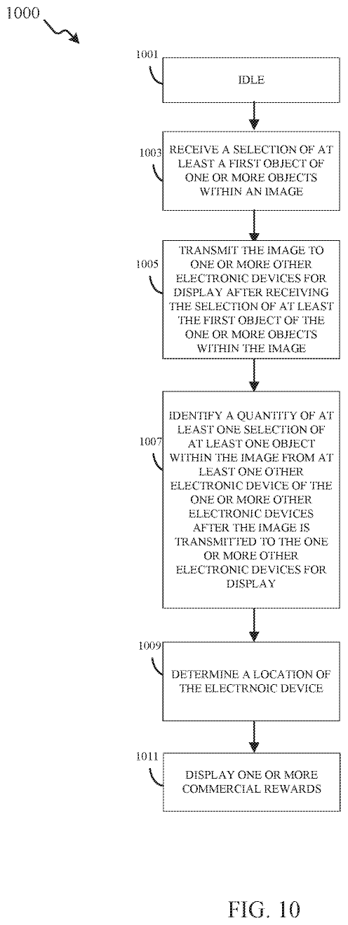

FIG. 10 illustrates a method 1000 implemented by the computing system 115 of an electronic device 110 performing one or more interactive dynamic product display operations according to certain embodiments of this disclosure. Although certain details will be provided with reference to the method 1000 of FIG. 10, it should be understood that other embodiments may include more, less, or different method steps. At step 1001, the computing system 115 of the electronic device 110 is in an idle state at least with respect to performing one or more interactive dynamic product display operations. Step 1001 is at least similar to step 701 illustrated in FIG. 7. At step 1003, the computing system 115 of the electronic device 110 receives a selection of at least a first object of one or more objects within an image. Step 1003 is at least similar to step 703 illustrated in FIG. 7. At step 1005, the computing system 115 of the electronic device 110 transmits the image to one or more other electronic devices for display after receiving the selection of at least the first object of the one or more objects within the image. Step 1005 is at least similar to step 705 illustrated in FIG. 7. At step 1007, the computing system 115 of the electronic device 110 identifies a quantity of at least one selection of at least one object within the image from at least one other electronic device of the one or more other electronic devices after the image is transmitted to the one or more other electronic devices for display. Step 1007 is at least similar to step 707 illustrated in FIG. 7. At step 1009, the computing system 115 of the electronic device 110 determines a location of the electronic device. Step 1009 is at least similar to step 709 illustrated in FIG. 7. At step 1011, the computing system 115 of the electronic device 110 displays one or more commercial rewards. Step 1011 is at least similar to step 711 illustrated in FIG. 7.

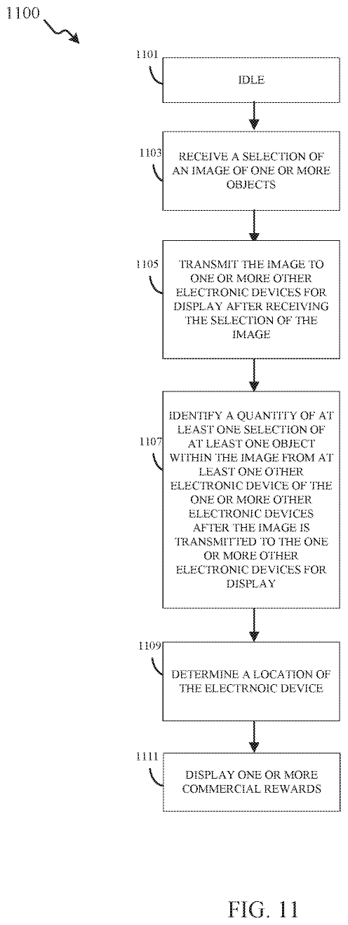

FIG. 11 illustrates a method 1100 implemented by the computing system 115 of an electronic device 110 performing one or more interactive dynamic product display operations according to certain embodiments of this disclosure. Although certain details will be provided with reference to the method 1100 of FIG. 11, it should be understood that other embodiments may include more, less, or different method steps. At step 1101, the computing system 115 of the electronic device 110 is in an idle state at least with respect to performing one or more interactive dynamic product display operations. Step 1101 is at least similar to step 701 illustrated in FIG. 7. At step 1103, the computing system 115 of the electronic device 110 receives a selection of an image of one or more objects. Step 1103 is at least similar to step 703 illustrated in FIG. 7. At step 1105, the computing system 115 of the electronic device 110 transmits the image to one or more other electronic devices for display after receiving the selection of at least the first object of the one or more objects within the image. Step 1105 is at least similar to step 705 illustrated in FIG. 7. At step 1107, the computing system 115 of the electronic device 110 identifies a quantity of at least one selection of at least one object within the image from at least one other electronic device of the one or more other electronic devices after the image is transmitted to the one or more other electronic devices for display. Step 1107 is at least similar to step 707 illustrated in FIG. 7. At step 1109, the computing system 115 of the electronic device 110 determines a location of the electronic device. Step 1109 is at least similar to step 709 illustrated in FIG. 7. At step 1111, the computing system 115 of the electronic device 110 displays one or more commercial rewards. Step 1011 is at least similar to step 711 illustrated in FIG. 7.

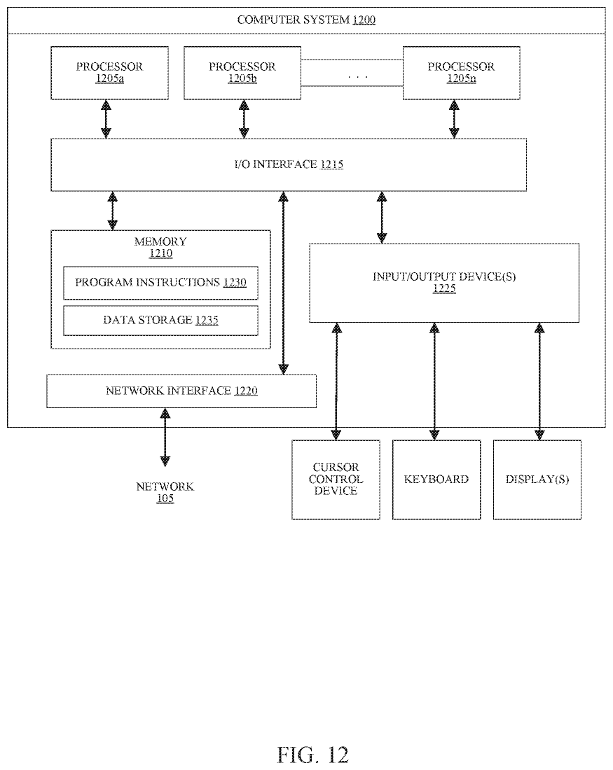

FIG. 12 illustrates a non-limiting, example computer system 1200 configured to implement systems and methods for performing one or more interactive gaming operations according to certain embodiments of this disclosure. FIG. 12 illustrates a computer system 1200 that is configured to execute any and all of the embodiments described herein. In certain embodiments, the computer system 1200 describes at least some of the components of electronic device 110 or the computing system 115 illustrated in FIGS. 1 and 2. In different embodiments, the computer system 1200 may be any of various types of devices, including, but not limited to, a computer embedded in a vehicle, a computer embedded in an appliance, a personal computer system, a desktop computer, a handset (e.g., a laptop computer, a notebook computer, a tablet, a slate, a netbook computer, a camera, a handheld video game device, a handheld computer, a video recording device, a consumer device, a portable storage device, or the like), a mainframe computer system, a workstation, network computer, a set top box, a video game console, a mobile device, an application server, a storage device, a television, a peripheral device such as a switch, modem, router, or in general any type of computing or electronic device.

Various embodiments of a system and method for performing one or more interactive dynamic product display operations, as described herein, may be executed on one or more computer systems 1200, which may interact with various other devices. In the illustrated embodiment, the computer system 1200 includes one or more processors 1205 coupled to a system memory 1210 via an input/output (I/O) interface 1215. The computer system 1200 further includes a network interface 1220 coupled to I/O interface 1215, and one or more input/output devices 1225, such as cursor control device, keyboard, and display(s). In some cases, it is contemplated that embodiments may be implemented using a single instance of computer system 1200, while in other embodiments multiple such systems, or multiple nodes making up computer system 1200, may be configured to host different portions or instances of embodiments. For example, in one embodiment some elements may be implemented via one or more nodes of computer system 1200 that are distinct from those nodes implementing other elements.

In various embodiments, computer system 1200 may be a uniprocessor system including one processor 1205a, or a multiprocessor system including several processors 1205a-1205n (e.g., two, five, eight, or another suitable number). The processors 1205 may be any suitable processor capable of executing instructions. For example, in various embodiments the processors 1205 may be general-purpose or embedded processors implementing any of a variety of instruction set architectures (ISAs), such as the x86, PowerPC, SPARC, or MIPS ISAs, or any other suitable ISA. In multiprocessor systems, each of processors 1205 may commonly, but not necessarily, implement the same ISA.

The system memory 1210 may be configured to store the program instructions 1230 and/or existing state information and ownership transition condition data in the data storage 1235 accessible by the processor 1205. In various embodiments, the system memory 1210 may be implemented using any suitable memory technology, such as static random access memory (SRAM), synchronous dynamic RAM (SDRAM), nonvolatile/Flash-type memory, or any other type of memory. In the illustrated embodiment, the program instructions 1230 may be configured to implement a system for performing one or more interactive dynamic product display operations incorporating any of the functionality, as described herein. In some embodiments, program instructions and/or data may be received, sent, or stored upon different types of computer-accessible media or on similar media separate from the system memory 1210 or the computer system 1200. The computer system 1200 is described as implementing at least some of the functionality of functional blocks of figures describe herein.

In one embodiment, the I/O interface 1215 may be configured to coordinate I/O traffic between the processor 1205, the system memory 1210, and any peripheral devices in the device, including the network interface 1220 or other peripheral interfaces, such as the input/output devices 1225. In some embodiments, the I/O interface 1215 may perform any necessary protocol, timing or other data transformations to convert data signals from one component (e.g., the system memory 1210) into a format suitable for use by another component (e.g., the processor 1205). In some embodiments, the I/O interface 1215 may include support for devices attached through various types of peripheral buses, such as a variant of the Peripheral Component Interconnect (PCI) bus standard or the Universal Serial Bus (USB) standard, for example. In some embodiments, the function of the I/O interface 1215 may be split into two or more separate components, such as a north bridge and a south bridge, for example. Also, in some embodiments some or all of the functionality of the I/O interface 1215, such as an interface to the system memory 1210, may be incorporated directly into the processor 1205.

The network interface 1220 may be configured to allow data to be exchanged between the computer system 1200 and other devices attached to the network 105 or between nodes of the computer system 1200. The network 105 may in various embodiments include one or more networks including but not limited to Local Area Networks (LANs) (e.g., an Ethernet or corporate network), Wide Area Networks (WANs) (e.g., the Internet), wireless data networks, some other electronic data network, a combination thereof, or the like. In various embodiments, the network interface 1220 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The input/output devices 1225 may, in some embodiments, include one or more display terminals, keyboards, keypads, touchpads, scanning devices, voice, or optical recognition devices, or any other devices suitable for entering or accessing data by one or more the computer systems 1200. Further, various other sensors may be included in the I/O devices 1225, such as imaging sensors, barometers, altimeters, LIDAR, or any suitable environmental sensor. Multiple input/output devices 1225 may be present in the computer system 1200 or may be distributed on various nodes of the computer system 1200. In some embodiments, similar input/output devices may be separate from the computer system 1200 and may interact with one or more nodes of the computer system 1200 through a wired or wireless connection, such as over the network interface 1220.

As shown in FIG. 12, the memory 1210 may include program instructions 1230, which may be processor-executable to implement any element or action, as described herein. In one embodiment, the program instructions may implement at least a portion of methods described herein, such as the methods illustrated by FIGS. 7-11. In other embodiments, different elements and data may be included. Note that the data storage 1235 may include any data or information such as data or information described herein.

Those skilled in the art will appreciate that the computer system 1200 is merely illustrative and is not intended to limit the scope of embodiments. In particular, the computer system and devices may include any combination of hardware or software that can perform the indicated functions, including computers, network devices, Internet appliances, PDAs, wireless phones, pagers, GPUs, specialized computer systems, information handling apparatuses, or the like. The computer system 1200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions, structured data) on a computer-accessible medium or a portable article to be read by an appropriate drive, various examples of which are described here. In some embodiments, instructions stored on a computer-accessible medium separate from the computer system 1200 may be transmitted to the computer system 1200 through transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, or the like), ROM, or the like. In some embodiments, a computer-accessible medium may include transmission media or signals such as electrical, electromagnetic, or digital signals, conveyed via a communication medium such as network and/or a wireless link.

Thus, the disclosure provides, among other things, a system for performing one or more interactive dynamic product display operations, including a computing system. None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. An electronic device, comprising:
a computing system including a memory and at least one processor, wherein the computing system is configured to:
receive a selection of an image of one or more objects;
transmit the image to one or more other electronic devices for display in response to receiving the selection of the image, wherein, when the image is transmitted to the one or more other electronic devices for display, the image includes an indication that the computing system has received the selection of the image;
identify a quantity of at least one other electronic device of the one or more other electronic devices that receives a selection of the image after the image is transmitted to the one or more other electronic devices for display;
determine a location of the electronic device; and
display one or more commercial rewards based on:
the quantity of the at least one other electronic device of the one or more other electronic devices that receives the selection of the image, and
the location of the electronic device.

2. The electronic device of claim 1, wherein the one or more commercial rewards are associated with the image.

3. The electronic device of claim 1, wherein the one or more commercial rewards are associated with at least one object of the one or more objects within the image.

4. The electronic device of claim 1, wherein the one or more commercial rewards are related to one or more retail stores that are associated with the image or at least one object of the one or more objects within the image.

5. The electronic device of claim 1, wherein at least one object of the one or more objects within the image comprises at least one of a furniture piece, a decorative item, an article of clothing, or a clothing accessory.

6. The electronic device of claim 1, wherein when the computing system determines that the location of the electronic device is a first location, the one or more commercial rewards comprise a first commercial reward, and wherein when the computing system determines that the location of the electronic device is a second location that is different from the first location, the one or more commercial rewards comprise a second commercial reward that is different from the first commercial reward.

7. The electronic device of claim 6, wherein the first location is a location that excludes a retail store that is associated with at least one object of the one or more objects within the image, and wherein the second location is a location that includes the retail store.

8. The electronic device of claim 6, wherein the second location is a location that is within a distance from a retail store that is associated with at least one object of the one or more objects within the image, and wherein the first location is a location that is beyond a distance from the retail store.

9. A method implemented by a computing system of an electronic device, the method comprising:
receiving, by the computing system, a selection of an image of one or more objects;
transmitting, by the computing system, the image to one or more other electronic devices for display in response to receiving the selection of the image, wherein, when the image is transmitted to the one or more other electronic devices for display, the image includes an indication that the computing system has received the selection of the image;
identifying, by the computing system, a quantity of at least one other electronic device of the one or more other electronic devices that receives a selection of the image after the image is transmitted to the one or more other electronic devices for display;
determining, by the computing system, a location of the electronic device; and
displaying, by the computing system, one or more commercial rewards based on:
the quantity of the at least one other electronic device of the one or more other electronic devices that receives the selection of the image, and
the location of the electronic device.

10. The method of claim 9, wherein the one or more commercial rewards are associated with the image.

11. The method of claim 9, wherein the one or more commercial rewards are associated with at least one object of the one or more objects within the image.

12. The method of claim 9, wherein the one or more commercial rewards are related to one or more retail stores that are associated with the image or at least one object of the one or more objects within the image.

13. The method of claim 9, wherein at least one object of the one or more objects within the image comprises at least one of a furniture piece, a decorative item, an article of clothing, or a clothing accessory.

14. The method of claim 9, wherein when the computing system determines that the location of the electronic device is a first location, the one or more commercial rewards comprise a first commercial reward, and wherein when the computing system determines that the location of the electronic device is a second location that is different from the first location, the one or more commercial rewards comprise a second commercial reward that is different from the first commercial reward.

15. A non-transitory, computer-readable storage medium storing one or more executable instructions that, when executed by at least one processor, cause the at least one processor to:
receive a selection of an image of one or more objects;
transmit the image to one or more other electronic devices for display in response to receiving the selection of the image, wherein, when the image is transmitted to the one or more other electronic devices for display, the image includes an indication that the at least one processor has received the selection of the image;
identify a quantity of at least one other electronic device of the one or more other electronic devices that receives a selection of the image after the image is transmitted to the one or more other electronic devices for display;
determine a location of the at least one processor; and
display one or more commercial rewards based on:
the quantity of the at least one other electronic device of the one or more other electronic devices that receives the selection of the image, and
the location of the at least one processor.

16. The non-transitory, computer-readable storage medium of claim 15, wherein the one or more commercial rewards are associated with the image.

17. The non-transitory, computer-readable storage medium of claim 15, wherein the one or more commercial rewards are associated with at least one object of the one or more objects within the image.

18. The non-transitory, computer-readable storage medium of claim 15, wherein the one or more commercial rewards are related to one or more retail stores that are associated with the image or at least one object of the one or more objects within the image.

19. The non-transitory, computer-readable storage medium of claim 15, wherein at least one object of the one or more objects within the image comprises at least one of a furniture piece, a decorative item, an article of clothing, or a clothing accessory.

20. The non-transitory, computer-readable storage medium of claim 15, wherein when the location of the at least one processor is determined to be a first location, the one or more commercial rewards comprise a first commercial reward, and wherein when the location of the at least one processor is determined to be a second location that is different from the first location, the one or more commercial rewards comprise a second commercial reward that is different from the first commercial reward.
